(19) United States
(12) Patent Application Publication
(10) Pub. No.: US 2024/0411247 A1
(43) Pub. Date: Dec. 12, 2024

(54) IMAGE FORMING SYSTEM

(71) Applicant: FUJIFILM Business Innovation Corp., Tokyo (JP)

(72) Inventors: Akihiro TAKAHASHI, Kanagawa (JP); Yoshiyuki TOMINAGA, Kanagawa (JP)

(73) Assignee: FUJIFILM Business Innovation Corp., Tokyo (JP)

(21) Appl. No.: 18/501,642

(22) Filed: Nov. 3, 2023

(30) Foreign Application Priority Data
Jun. 6, 2023 (JP) 2023-093427

(51) Int. Cl. G03G 15/16

(52) U.S. Cl. CPC G03G 15/1645; G03G 2215/00042; G03G 2215/00388

(57) ABSTRACT

An image forming system includes an image holding unit that is rotatably provided and that holds an image formed by means of a charged image forming material, a transfer unit that transfers the image hold by the image holding unit to a medium by using a transfer electric field, a fine particle applying unit that periodically or irregularly applies lubricant fine particles to the image holding unit, and a transfer control unit that controls the transfer electric field of the transfer unit depending on a state of application of the fine particles on the image holding unit.

### CROSS-REFERENCE TO RELATED APPLICATIONS

This application is based on and claims priority under 35 USC 119 from Japanese Patent Application No. 2023-093427 filed Jun. 6, 2023.

### BACKGROUND

### (i) Technical Field

The present invention relates to an image forming system.

### (ii) Related Art

Disclosed in JP2000-259011A (Mode For Carrying Out The Invention and FIG. 3) is an image recording apparatus including an intermediate transfer body 5a that comes into contact with image carriers 1K and 1Y, an intermediate transfer body 5b that comes into contact with image carriers 1M and 1C, an intermediate transfer body 6 that comes into contact with the intermediate transfer bodies 5a and 5b, and fine particle adhesion tools 20a, 20b, and 20c that cause fine particles, of which the average particle size is three times or smaller the average particle size of primary particles, to adhere to surfaces of the intermediate transfer bodies 5a, 5b, and 6.

Disclosed in JP2006-313377A (Best Mode For Carrying Out The Invention and FIG. 2) is an image forming apparatus including an image carrier with a surface on which a toner image is formed, an intermediate transfer body that receives the toner image transferred from the image carrier and that transfers the toner image to the next, and a fine particle adhesion device that causes fine particles to adhere to a surface of the intermediate transfer body, the fine particle adhesion device including a rotary brush and a rod-shaped member that comes into contact with bristles of the rotary brush, that is supported to be parallel to the rotary brush, and that is for brushing off surplus fine particles.

Disclosed in JP3475697B (Mode For Carrying Out The Invention and FIG. 1) is an image forming apparatus in which fine particles circulate between a circumferential surface of an image carrier and a circumferential surface of an intermediate transfer body so that the number of fine particles are kept substantially even on each of the circumferential surfaces and the fine particles are interposed between the image carrier and a toner image and the intermediate transfer body and the toner image so that the efficiency of transfer of the toner image is improved.

### SUMMARY

Aspects of non-limiting embodiments of the present disclosure relate to an image forming system that stably maintains the efficiency of image transfer without being influenced by the state of application of fine particles in relation to an aspect in which fine particles can be applied to an image holding unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including an image holding unit that is rotatably provided and that holds an image formed by means of a charged image forming material, a transfer unit that transfers the image hold by the image holding unit to a medium by using a transfer electric field, a fine particle applying unit that periodically or irregularly applies lubricant fine particles to the image holding unit, and a transfer control unit that controls the transfer electric field of the transfer unit depending on a state of application of the fine particles on the image holding unit.

### BRIEF DESCRIPTION OF THE DRAWINGS

Exemplary embodiment(s) of the present invention will be described in detail based on the following figures, wherein:

FIG. 1A is an explanatory view showing an outline of an exemplary embodiment of an image forming system to which the present invention is applied, FIG. 1B is an explanatory view showing how a surface of an image holding unit and an image are in a transfer region in a case where a normal medium is used, and FIG. 1C is an explanatory view showing how the surface of the image holding unit and the image are in the transfer region in a case where an embossed medium is used;

FIG. 2 is an explanatory view showing an overall configuration of an image forming system according to Exemplary Embodiment 1;

FIG. 3A is an explanatory view showing details of an image forming unit and FIG. 3B is an explanatory view showing details of an intermediate transfer body cleaning device;

FIG. 4A is an explanatory view showing details of a transfer device, FIG. 4B is an explanatory view schematically showing a transfer operation in a normal image forming mode shown in part B in FIG. 4A, and FIG. 4C is an explanatory view schematically showing a transfer operation in a special image forming mode;

FIG. 5A is an explanatory view showing an example of a fine particle applying device used in Exemplary Embodiment 1, FIG. 5B is an explanatory view showing how the fine particle applying device is in a case where an image forming operation is finished, and FIG. 5C is an explanatory view showing how the fine particle applying device is in a case where supply of fine particles is started;

FIG. 6A is an explanatory view conceptually showing an operation of applying fine particles to an intermediate transfer body which is performed by the fine particle applying device and FIG. 6B is an explanatory view schematically showing a principle by which an application roller shown in FIG. 6A applies the fine particles to the intermediate transfer body;

FIG. 7A is an explanatory view showing an example of disposition of an optical sensor that detects the state of application of fine particles on the intermediate transfer body, FIG. 7B is a view as seen along arrow B in FIG. 7A, FIG. 7C is an explanatory view showing the state of detection performed by the optical sensor in a situation in which fine particles are not applied onto the intermediate transfer body, FIG. 7D is an explanatory view showing the state of detection performed by the optical in a situation in which the fine particles have been applied onto the intermediate transfer body, and FIG. 7E is an explanatory diagram showing an example of a relationship between a fine particle coverage rate on the intermediate transfer body and the output power of the optical sensor;

FIG. 8A is a graph showing a relationship between the fine particle coverage rate on the intermediate transfer body and a toner adhesion force, FIG. 8B is an explanatory diagram schematically showing a relationship between a fine particle application amount to the intermediate transfer body and the toner adhesion force, and FIG. 8C is an explanatory diagram showing a relationship between a transfer bias and whether or not an image quality is favorable regarding whether or not the fine particles are applied;

FIG. 9 is an explanatory view showing a control system of the image forming system according to Exemplary Embodiment 1;

FIG. 10 is a flowchart showing an example of the way in which fine particle application control used in Exemplary Embodiment 1 is performed;

FIG. 11 is a flowchart showing an example of the way in which bias control of the transfer device used in Exemplary Embodiment 1 is performed;

FIG. 12 is an explanatory view showing Modification Exemplary Embodiment 1-1 of the fine particle applying device used in Exemplary Embodiment 1;

FIG. 13 is an explanatory view showing Modification Exemplary Embodiment 1-2 of the fine particle applying device used in Exemplary Embodiment 1;

FIG. 14 is a flowchart showing an example of the way in which fine particle application control used in an image forming system according to Exemplary Embodiment 2 is performed;

FIG. 15 is a flowchart showing an example of the way in which bias control of a transfer device used in Exemplary Embodiment 2 is performed;

FIG. 16A is a graph showing a relationship between the fine particle coverage rate and a bias decrease amount ΔV of a transfer bias of the transfer device and

FIG. 16B is an explanatory diagram showing a relationship between the transfer bias and whether or not an image quality is favorable regarding whether or not the fine particles are applied;

FIG. 17A is an explanatory view schematically showing a transfer operation of the transfer device in a normal image forming mode,

FIG. 17B is an explanatory view schematically showing the transfer operation of the transfer device that is performed in a special image forming mode in a case where the fine particle coverage rate is smaller than a threshold value TH2, and

FIG. 17C is an explanatory view schematically showing a transfer operation of the transfer device that is performed in a special image forming mode in a case where the fine particle coverage rate is equal to or larger than the threshold value TH2;

FIG. 18 is an explanatory view showing a major part of an image forming system according to Exemplary Embodiment 3;

FIG. 19 shows a result of examination about a relationship between a particle size of fine particles in an applied-fine-particle layer and an adhesion force of toner with respect to the intermediate transfer body; and

FIG. 20 shows a result of examination about a relationship between a toner adhesion force with respect to the intermediate transfer body and a transferability grade.

### DETAILED DESCRIPTION

### Outline of Exemplary Embodiment

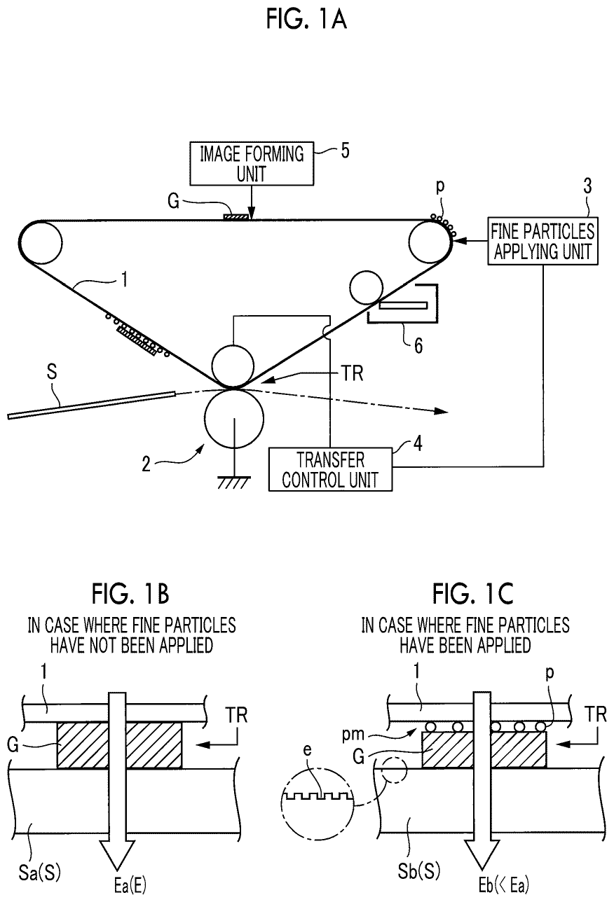

FIG. 1A shows an outline of an exemplary embodiment of an image forming system to which the present invention is applied.

In the drawing, the image forming system includes an image holding unit 1 that is rotatably provided and that holds an image G formed by means of a charged image forming material, a transfer unit 2 that transfers the image G hold by the image holding unit 1 to a medium S by using a transfer electric field, a fine particle applying unit 3 that periodically or irregularly applies lubricant fine particles p to the image holding unit 1, and a transfer control unit 4 that controls the transfer electric field of the transfer unit 2 depending on the state of application of the fine particles p on the image holding unit 1.

Note that in FIG. 1A, a reference numeral “5” denotes an image forming unit that forms the image G on the image holding unit 1 by means of the image forming material and a reference numeral “6” denotes a cleaning unit that removes residue remaining on the image holding unit 1 after a transfer operation performed by the transfer unit 2.

In such technical units, the “image forming system” of the present application is not limited to a system composed of a single device, and also means a system composed of a plurality of devices.

In addition, as long as the image holding unit 1 holds the image G formed by an image formation unit, the image holding unit 1 may be an image forming and holding unit such as a photoconductor and a dielectric substance that directly form the image G and hold the image G and may be an intermediate transfer unit that intermediately holds the image G formed by an image forming and holding unit before the image G is transferred to the medium S.

Here, as long as the image forming unit 5 is a type of image forming unit that forms an image by using a charged image forming material, the image forming unit 5 is not limited to an electrophotographic image forming unit and the meaning thereof includes various types of image forming units such as an electrostatic recording type image forming unit which uses an ion current.

In addition, as the transfer unit 2, any transfer unit may be selected as appropriate as long as the transfer unit uses a transfer electric field to transfer the image G hold by the image holding unit 1 to the medium S and an aspect in which a transfer electric field is used for pressure-transfer is a typical.

Furthermore, as the medium S, any one of mediums with various physical properties may be selected as appropriate. For example, in a case where a normal medium Sa such as plain paper is used as the medium S, as shown in FIG. 1B, since a surface of the normal medium Sa is substantially smooth, the image G on the image holding unit 1 is easily transferred onto the normal medium Sa via an transfer electric field Ea (E) in a transfer region TR and transfer failure is unlikely to occur. However, for example, in a case where an embossed medium Sb (refer to FIG. 1C) having unevenness (an embossment) e on a surface is used as the medium S, transferability of the image G on the image holding unit 1 tends to decrease due to the influence of the unevenness (an embossment) e on the surface of the embossed medium Sb. This is because transfer of the image G is more difficult at a recess portion of the unevenness (an embossment) e on the surface of the embossed medium Sb than at a protruding portion. In order to avoid such a problem, in the present example, the fine particle applying unit 3 applies the lubricant fine particles p onto the image holding unit 1 for improvement of transferability of the image G in a case where the embossed medium Sb is to be used, as shown in FIG. 1C. As the “fine particles p” referred to here, any fine particles may be selected as appropriate as long as the particles are lubricant. For example, in the case of an aspect in which the image forming unit 5 uses an image forming material containing a lubricant external additive is used, the same fine particles as the external additive can be used.

In addition, the transfer control unit 4 may be any transfer control unit as long as the transfer control unit controls a transfer operation of the transfer unit 2 based on the state of application (for example, whether or not the fine particles are present or the amount of applied fine particles) of the fine particles p applied by the fine particle applying unit 3 based on a fact that a layer of applied fine particles p reduces an adhesion force with respect to the image holding unit 1.

Specifically, to be controlled may be a transfer electric field E of the transfer unit 2, a normal transfer condition (in the present example, Ea is selected as the transfer electric field E) may be used in a case where there are no fine particles p applied on the image holding unit 1, and another transfer condition (in the present example, Eb (<EA) is selected as the transfer electric field E) may be used in a case where there are fine particles p applied on the image holding unit 1.

Furthermore, as the cleaning unit 6, any cleaning unit may be selected as appropriate as long as the cleaning unit removes residue (toner, paper dust, fine particles, or the like) remaining on the image holding unit 1. However, from the viewpoint of removing the fine particles p of which the diameter is smaller than the diameter of an image forming material such as toner, for example, it is preferable that an aspect (a so-called blade cleaning type cleaning unit) in which a cleaning unit is composed of an elastic plate-shaped portion and a tip end of the cleaning unit comes into contact with the image holding unit 1 in a state of being inclined in a direction facing a rotation direction of the image holding unit 1 is adopted.

Next, for example, a representative aspect or a preferable aspect of an image forming system according to the present exemplary embodiment will be described.

First, examples of a representative aspect of the transfer control unit 4 include an aspect in which control is performed such that the transfer electric field E of the transfer unit 2 differs between a condition in which the fine particles p have been applied and a condition in which the fine particles p have not been applied. In the present aspect, the transfer electric field E of the transfer unit 2 differs depending on whether or not the fine particles p have been applied.

Specific examples of the present aspect include an aspect in which control is performed such that the transfer electric field E of the transfer unit 2 is made small on a condition in which the fine particles p have been applied in comparison with a condition in which the fine particles p have not been applied.

In addition, examples of another representative aspect of the transfer control unit 4 include an aspect in which control is performed such that the transfer electric field E of the transfer unit 2 differs depending on the amount of application of the fine particles p on a condition in which the fine particles p have been applied. In the present aspect, the transfer electric field E of the transfer unit 2 differs depending on the amount of application of the fine particles p.

Specific examples of the present aspect include an aspect in which, in a case where the amount of application of the fine particles p is smaller than a first threshold value determined in advance, control is performed such that the transfer electric field E of the transfer unit 2 is made equal to the transfer electric field E formed on a condition in which the fine particles p have not been applied. Here, the first threshold value means the minimum value at which the amount of application of the fine particles p somewhat influences the adhesion force of the image G and in a case where the amount of application of the fine particles p is smaller than the first threshold value, the transfer electric field E of the transfer unit 2 is handled in the same manner as in the case of a condition in which the fine particles p have not been applied based on a fact that the adhesion force of the image G exerted in the case where the amount of application of the fine particles p is smaller than the first threshold value is not greatly different from the adhesion force exerted in a case where the fine particles p have not been applied.

In addition, other specific examples of the present aspect include an aspect in which, in a case where the amount of application of the fine particles p exceeds a second threshold value determined in advance, control is performed such that the transfer electric field E of the transfer unit 2 is made large in comparison with a case where the amount of application of the fine particles p is equal to or smaller than the second threshold value. This is because, in a case where the amount of application of the fine particles p is excessive and exceeds to the second threshold value, the number of points of contact between the fine particles p and the image G is increased and the adhesion force of the image G with respect to the image holding unit 1 is increased again due to an increase in van der Waals force. Here, the second threshold value means a boundary value at which the amount of application of the fine particles p starts to tends to increase the adhesion force of the image G after reduction of the adhesion force of the image G and in a case where the amount of application of the fine particles p exceeds the second threshold value, the transfer electric field E of the transfer unit 2 is handled to be large in comparison with a case where the amount of application of the fine particles p is equal to or smaller than the second threshold value, since the adhesion force of the image G is increased again in a case where the amount of application of the fine particles p exceeds the second threshold value.

Furthermore, examples of an aspect of the transfer control unit 4 include an aspect in which a coverage rate of the fine particles p is used as the amount of application of the fine particles p on a condition in which the fine particles p have been applied and the transfer electric field E of the transfer unit 2 is controlled based on a relationship between the coverage rate of the fine particles p and an adhesion force of the image G with respect to the image holding unit 1. In the present example, the amount of application of the fine particles p is calculated from the coverage rate of the fine particles p and the relationship between the coverage rate of the fine particles p and the adhesion force of the image G is obtained so that the transfer electric field E of the transfer unit 2 is controlled based on the relationship.

In addition, examples of an aspect of the transfer control unit 4 include an aspect in which a detection unit (not shown) that is able to detect the state of application of the fine particles p is provided and the transfer electric field E of the transfer unit 2 is controlled based on the result of detection performed by the detection unit. In the present aspect, the state of application of the fine particles p is detected by the detection unit so that the transfer electric field E of the transfer unit 2 appropriate for the state of application of the fine particles p is selected.

In the present example, examples of the detection unit include the detection unit is composed of a reflection type optical sensor that is disposed to face a layer of the applied fine particles p.

Furthermore, examples of an aspect of the fine particle applying unit 3 include an aspect in which the fine particles p of which the particle size falls within a range of 30 to 150 nm are applied to the image holding unit 1 having a surface roughness Rz of 1.5 or less or a microgloss of 93 or more. In the present aspect, as shown in FIG. 1C, in a case where the embossed medium Sb is used, an appropriate range is selected for the surface properties of the image holding unit 1 and the particle size of the fine particles p from the viewpoint of reducing the adhesion force of the image G on the image holding unit 1.

Hereinafter, the present invention will be described in more detail on the basis of the exemplary embodiments shown in the accompanying drawings.

### Exemplary Embodiment 1

### Overall Configuration of Image Forming System

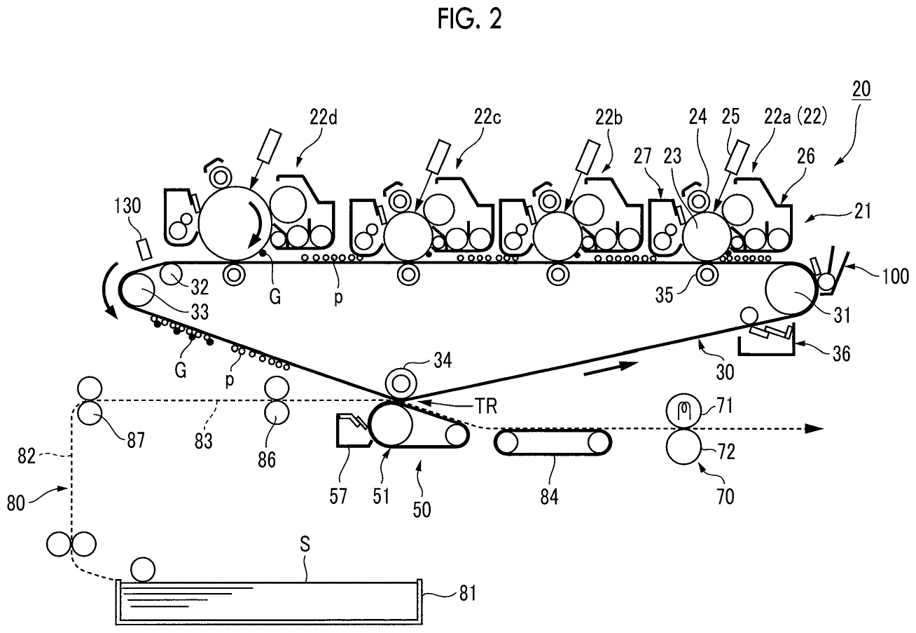

FIG. 2 shows the overall configuration of the image forming system according to the first exemplary embodiment.

In the drawing, an image forming system 20 includes an image forming engine 21 that is installed in an apparatus housing (not shown) and that produces a plurality of color component images (in the present exemplary embodiment, four colors which are yellow (Y), magenta (M), cyan (C), and black (K)), a transfer device 50 that transfers, to the medium S, each of the color component images produced by the image forming engine 21, a fixing device 70 that fixes, onto the medium S, each of the color component images transferred in the transfer region TR of the transfer device 50, and a medium transport system 80 that transports the medium S to the transfer region TR of the transfer device 50.

### Configuration Example of Image Forming Engine

In the present example, the image forming engine 21 includes image forming units 22 (specifically, image forming units 22a to 22d) that form a plurality of color component images and a belt-shaped intermediate transfer body 30 onto which the color component images respectively formed by the image forming units 22 are sequentially transferred (primary transfer) to be held and that transports the color component images to a portion for transfer to the medium S.

### Image Forming Unit

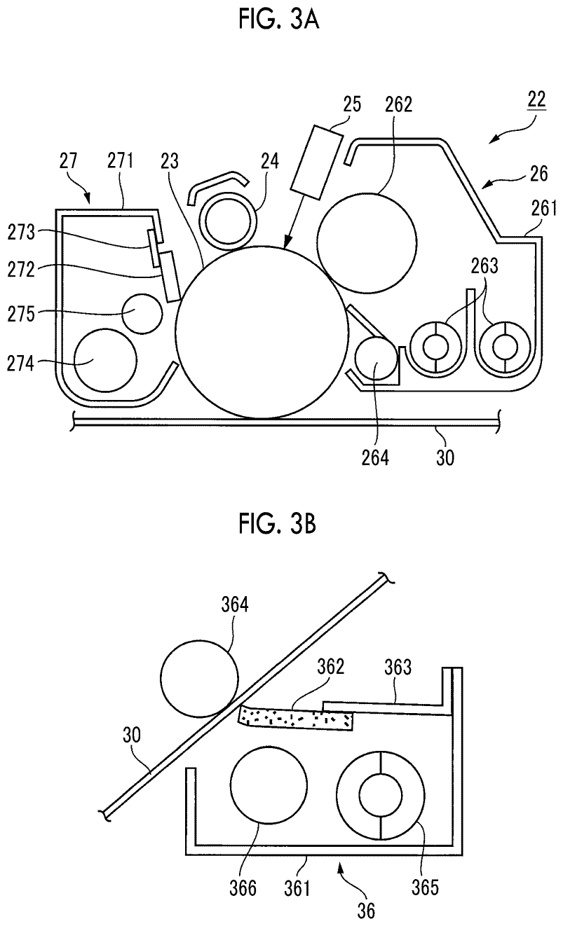

In the present exemplary embodiment, as shown in FIGS. 2 and 3A, for example, an electrophotographic image forming unit is adopted as each of the image forming units 22 (22a to 22d) and each of the image forming units 22 includes a drum-shaped photoconductor 23. Around each photoconductor 23, a charging device 24 at which the photoconductor 23 is charged, an optical writing device 25 at which an electrostatic latent image is written on the charged photoconductor 23, a development device 26 at which the electrostatic latent image written on the photoconductor 23 is developed by each color component toner, and a photoconductor cleaning device 27 at which toner remaining on the photoconductor 23 is removed after transfer of an image to the intermediate transfer body 30 are disposed.

Here, in the present example, a charging roller is used as the charging device 24, for example. However, a corotron, a scorotron, or the like may also be selected as appropriate. In addition, in the present example, an LED array is used as the optical writing device 25, for example. However a laser scanning device or the like may also be selected as appropriate.

Furthermore, as the development device 26, any development device may be selected as appropriate as long as the development device uses a developer as an image forming material. The present example is an aspect in which a two-component development type development device is adopted. The development device 26 includes a development housing 261 with an opening facing the photoconductor 23, a development roller 262 is disposed to face the opening of the development housing 261, a two-component developer containing a toner (including an external additive) and a carrier is accommodated in the development housing 261, and the developer is held by the development roller 262 while the developer is being agitated and transported by a set of agitating and transporting members 263 and the toner is being charged so that the electrostatic latent image on the photoconductor 23 is toner-developed. Note that a reference numeral “264” denotes a recovery member that returns the developer fallen from the development roller 262 toward the agitating and transporting member 263 side.

In addition, in the present example, the photoconductor cleaning device 27 includes a cleaning housing 271 with an opening that faces the photoconductor 23 and an elastic plate-shaped cleaning member 272 is provided at an edge of the opening of the cleaning housing 271 via a supporting bracket 273. Here, the cleaning member 272 is disposed such that a tip end portion comes into contact with the photoconductor 23 in a state of being inclined in a direction facing a rotation direction of the photoconductor 23 and the cleaning member 272 scrapes off and removes residue remaining on the photoconductor 23. In addition, a leveling and transporting member 274 is provided at a bottom portion of the cleaning housing 271 to level residue accommodated in the cleaning housing 271 and to transport the residue to the outside of the cleaning housing 271 in a direction toward a recovery container (not shown) at the time of disposal. Note that a reference numeral “275” denotes a guide member that guides, to the leveling and transporting member 274 side, the residue scraped off by the cleaning member 272.

### Intermediate Transfer Body

In addition, the intermediate transfer body 30 is looped over a plurality of tension rollers 31 to 34. For example, the tension roller 31 is used as a drive roller driven by a drive motor (not shown) and the intermediate transfer body 30 is circulated and moved by the drive roller.

In the present example, the photoconductor 23 of each image forming unit 22 is disposed to face a surface of the intermediate transfer body 30 that is positioned between the tension rollers 31 and 32 and primary transfer devices 35 such as transfer rollers that electrostatically transfer images formed on the photoconductors 23 to the intermediate transfer body 30 side are provided at an inner surface of the intermediate transfer body 30 facing each photoconductor 23.

### Intermediate Transfer Body Cleaning Device

Furthermore, an intermediate transfer body cleaning device 36 that removes residue such as a residual toner and paper dust on the intermediate transfer body 30 after image transfer to the medium S is provided at a surface of the intermediate transfer body 30 that is positioned between the tension rollers 31 and 34.

In the present example, as shown in FIGS. 2 and 3B, the intermediate transfer body cleaning device 36 is disposed at a portion of the intermediate transfer body 30 that is closer to a downstream side in a rotation direction than the transfer region TR (corresponding to the position of the tension roller 34) of the transfer device 50 is and that is close to the tension roller 31. The intermediate transfer body cleaning device 36 includes a cleaning housing 361 with an opening that faces the surface of the intermediate transfer body 30, an elastic plate-shaped cleaning member 362 is provided at an edge of the opening of the cleaning housing 361 via a supporting bracket 363, and a facing roller 364 is provided at an inner surface of the intermediate transfer body 30 that faces the cleaning member 362. Here, the cleaning member 362 is disposed such that a tip end portion comes into contact with the intermediate transfer body 30 in a state of being inclined in a direction facing a rotation direction of the intermediate transfer body 30 and the cleaning member 362 scrapes off and removes residue remaining on the intermediate transfer body 30. Furthermore, in the cleaning housing 361, a leveling and transporting member 365 that levels and transports accommodated residue and a guide member 366 that guides, to the leveling and transporting member 365 side, the residue scraped off by the cleaning member 362 are provided. Note that it is a matter of course that a cleaning member other than the plate-shaped cleaning member 362 like a cleaning brush may also be provided.

### Transfer Device

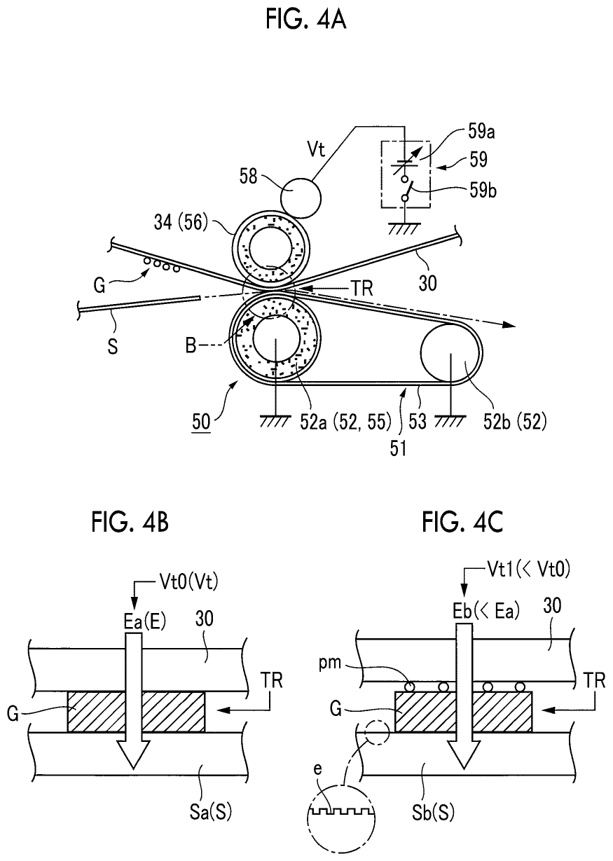

Furthermore, as shown in FIGS. 2 and 4A, the transfer device 50 secondarily transfers, to the medium S, the image G primarily transferred onto the intermediate transfer body 30. In the present example, regarding the transfer device 50, a belt transfer module 51 of which a transfer transport belt 53 is stretched on a plurality of tension rollers 52 (specifically, tension rollers 52a and 52b) is disposed to come into contact with a surface of the intermediate transfer body 30. Here, the transfer transport belt 53 is a semi-conductive belt that is formed of chloroprene or the like and that has a volume resistivity of 10⁶ to 10¹² Ωcm. One tension roller 52a is configured as an elastic transfer roller 55 and the elastic transfer roller 55 is disposed to come into pressure-contact with the transfer region TR of the intermediate transfer body 30 with the transfer transport belt 53 interposed therebetween. In addition, the tension roller 34 of the intermediate transfer body 30 is disposed to face the elastic transfer roller 55 as a facing roller 56 serving as a counter electrode of the elastic transfer roller 55. Furthermore, the transfer transport belt 53 forms a transport path for the medium S from the position of the one tension roller 52a to the position of the other tension roller 52b. Note that in FIG. 2, a reference numeral “57” denotes a transfer cleaning device that cleans the transfer transport belt 53.

In addition, in the present example, the elastic transfer roller 55 has a configuration in which a periphery of a metal shaft is covered with an elastic layer obtained by blending urethane foam rubber or EPDM with carbon black and the like. Furthermore, a transfer bias Vt from a transfer power source 59 is applied to the facing roller 56 (in the present example, also serves as the tension roller 34) via a conductive power supply roller 58. The transfer power source 59 includes a variable power source unit 59a and a switch unit 59b that turns on and off the variable power source unit 59a. Meanwhile, the elastic transfer roller 55 (the one tension roller 52a) is grounded via a metal shaft (not shown) and as shown in FIG. 4B, the predetermined transfer electric field E is formed between the elastic transfer roller 55 and the facing roller 56 so that the image G on the intermediate transfer body 30 is transferred to the medium S.

Note that the other tension roller 52b is also grounded to prevent the transfer transport belt 53 from being charged. In addition, in consideration of the peelability of the medium S at a downstream end of the transfer transport belt 53, it is effective that the tension roller 52b on a downstream side has a smaller diameter than the diameter of the tension roller 52a on an upstream side since the tension roller 52b also functions as a separation roller.

### Fixation Device

The fixing device 70 is a device that includes a heating and fixing roller 71 which can be driven to be rotated and is disposed to be in contact with an image holding surface side of the medium S and a pressurizing and fixing roller 72 which is disposed to come into pressure contact with the heating and fixing roller 71 and to face the heating and fixing roller 71 and rotates as the heating and fixing roller 71 rotates, that causes an image held on the medium S to pass through a pressure contact region between both fixing rollers 71 and 72, and that heats, pressurizes, and fixes the image.

Note that a fixation method of the fixing device 70 is not limited to an aspect described in the exemplary embodiment and a non-contact fixation method, a fixation method in which laser light is used, or the like may also be selected as appropriate.

### Medium Transport System

Furthermore, the medium transport system 80 includes, for example, one medium supply container 81 from which the medium S can be supplied and in the medium transport system 80, the medium S supplied from the medium supply container 81 reaches the transfer region TR from a vertical transport path 82 extending in an approximately vertical direction via a horizontal transport path 83 extending in an approximately horizontal direction and then the medium S holding a transferred image reaches a fixation region of the fixing device 70 via a transport belt 84 and is discharged to a medium discharge receiver (not shown) provided beside the apparatus housing (not shown). In addition, in the medium transport system 80, in addition to a position aligning roller 86 that aligns the position of the medium S and supplies the medium S to the transfer region TR, an appropriate number of transport rollers 87 are provided for each of the transport paths 82 and 83.

Note that in the present example, the medium S is discharged to the medium discharge receiver (not shown) from the one medium supply container 81 via the vertical transport path 82 and the horizontal transport path 83. However, the present invention is not limited thereto and the design of the medium transport system 80 may be changed as appropriate depending on the specifications of the image forming engine 21. Here, examples of a modification example of the medium transport system 80 include an aspect in which a plurality of the medium supply containers 81 are used, an aspect in which a branch transport path that branches off downward is provided at a portion of the horizontal transport path 83 that is positioned downstream of the fixing device 70 in a medium transport direction and a medium inverting mechanism is provided in the middle of the branch transport path so that the medium S is discharged to the medium discharge receiver after being inverted, and an aspect in which the medium S inverted by the above-described medium inverting mechanism is returned from the vertical transport path 82 to the horizontal transport path 83 via a return transport path (not shown) so that the image G is transferred to a rear surface of the medium S at the transfer region TR.

### Fine Particle Applying Device

### Purpose of Use of Fine Particle Applying Device

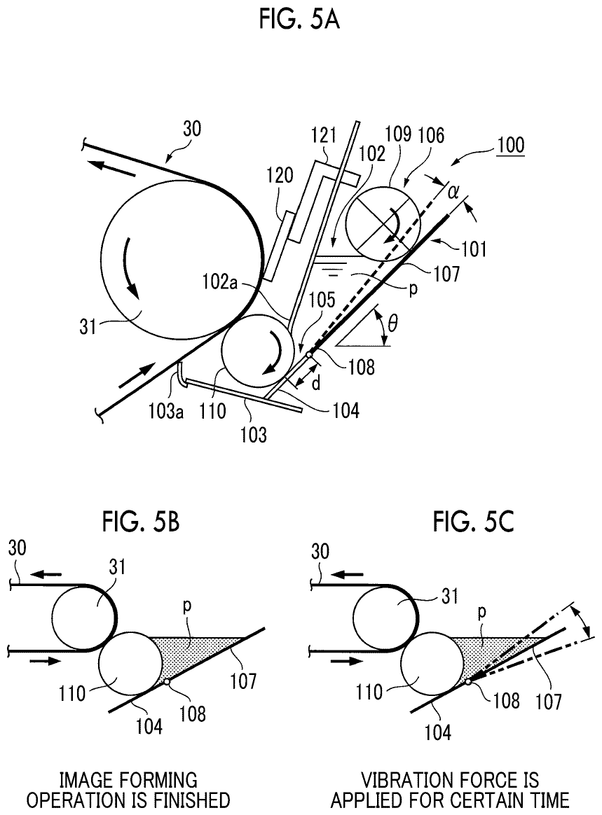

In the present example, as shown in FIGS. 2 and 5A, the intermediate transfer body 30 is provided with a fine particle applying device 100 that applies fine particles having excellent lubricity to a surface of the intermediate transfer body 30.

The fine particle applying device 100 is disposed, for example, at a portion of the intermediate transfer body 30 that is looped over the tension roller 31, and in a case where a fine particle application condition determined in advance is satisfied, the fine particle applying device 100 applies fine particles onto the intermediate transfer body 30 so that the image G is held on an applied-fine-particle layer.

Here, examples of the fine particle application condition include a condition in which the medium S to be used is an embossed medium such as embossed paper having unevenness (an embossment) on a surface thereof.

In the present example, in a case where the medium S is an embossed medium, it is difficult for the image G held on the intermediate transfer body 30 to be transferred to the embossed medium due to the influence of unevenness on a surface of the embossed medium and a transfer failure may be likely to occur. In the present example, in order to prevent such a situation, under an image forming condition in which an embossed medium is used as the medium S, an appropriate amount of fine particles is applied onto the intermediate transfer body 30 so that the image G is held on an applied-fine-particle layer, the adhesion force of the image G with respect to the intermediate transfer body 30 is reduced, and the transferability of the image G to the embossed medium is improved.

### Fine Particles

In the present example, although any fine particles may be selected as appropriate as long as the fine particles are excellent in lubricity, fine particles (for example, silica) that are already used as external additives for a toner are used as the fine particles p in the present example.

As described above, the reason why the same fine particles as the external additives of the toner are used as the fine particles p is that the fine particles are used as the external additives of the toner in the related art and have high reliability and the effect of the fine particles can be more stably maintained since the fine particles also serve as the external additives and the fine particles separated from the toner are supplied to the intermediate transfer body 30.

Examples of the material of the fine particles p include, in addition to silica, inorganic fine powders of titanium oxide, alumina, barium titanate, calcium titanate, strontium titanate, zinc oxide, magnesium oxide, zirconium oxide, barium sulfate, barium carbonate, calcium carbonate, silicon carbide, silicon nitride, chromium oxide, and red iron oxide, and organic fine powders of polyacrylate, polymethacrylate, polymethylmethacrylate, polyethylene, polypropylene, polyvinylidene fluoride, and polytetrafluoroethylene. For example, in consideration of environmental stability, it is desirable that the hygroscopicity of the fine particles is low, and in the case of hygroscopic inorganic fine powders such as titanium oxide, alumina, and silica, it is desirable to use such inorganic fine powders subjected to a hydrophobization treatment. The hydrophobization treatment of the inorganic fine powders can be performed by causing a silane coupling agent such as dimethyldichlorosilane, decylsilane, dialkyldihalogenated silane, trialkylhalogenated silane, and alkyltrihalogenated silane in addition to hexamethyldisilazane or a hydrophobization treatment such as dimethylsilicon oil to react with the above-described fine powders at a high temperature.

In addition, the particle size of the fine particles p may be selected as appropriate depending on the surface properties of the intermediate transfer body 30 to which the fine particles p are to be applied. However, in the present example, the fine particles p having a particle size falling within a range of 30 to 150 nm are selected for the intermediate transfer body 30 having a surface roughness Rz of 1.5 or less or a microgloss of 93 or more.

The way in which the fine particles p are selected is based on the results of Examples which will be described later.

### Configuration Example of Fine Particle Applying Device

In the present example, as shown in FIG. 5A, the fine particle applying device 100 includes an application container 101 with an opening that faces a portion of the intermediate transfer body 30 that is looped over the tension roller 31, an application roller 110 that is disposed to face the opening of the application container 101 and that comes into contact with the intermediate transfer body 30 to apply the fine particles p, and a plate-shaped leveling member 120 that makes the amount of application even over an applied-fine-particle layer pm applied to the intermediate transfer body 30.

Here, the application container 101 includes an accommodation portion 102 that is provided above the application roller 110, in which the powdery fine particles p are accommodated, and from which the fine particles p are supplied to the application roller 110 through a lower opening, a plate-shaped partition portion 103 that is provided below the application roller 110 to partition a container space and a plate-shaped restriction portion 104 that is provided between the accommodation portion 102 and the partition portion 103 and that is disposed to come into contact with the application roller 110 on a side opposite to a point of contact between the application roller 110 and the intermediate transfer body 30.

Note that in FIG. 5A, an edge portion of the lower opening of the accommodation portion 102 is provided with a seal member 102a that elastically comes into contact with the application roller 110 is and an end portion of the partition portion 103 that is on the intermediate transfer body 30 side is provided with a seal member 103a that elastically comes into contact with the intermediate transfer body 30.

### Application Container

In addition, in the present example, a wedge-shaped gap 105 is formed between the application roller 110 and the restriction portion 104. Therefore, a filling mechanism 106 that fills the wedge-shaped gap 105 with the fine particles p is provided in a portion of the accommodation portion 102. In the present example, the accommodation portion 102 is disposed such that an accommodation side plate 107 connected to the restriction portion 104 is inclined like a slide at an angle θ of 45 degrees or more with respect to the horizontal direction. In addition, regarding the filling mechanism 106, the accommodation side plate 107 is swingably supported with respect to the restriction portion 104 via, for example, a hinge 108, a rotation paddle 109 as a swinging unit is disposed to come into contact with a portion of the accommodation side plate 107 that is separated from the hinge 108, and the slide-shaped accommodation side plate 107 disposed to be inclined is swung at an angle α (for example, 10 degrees to 15 degrees) determined in advance via the rotation paddle 109 so that the wedge-shaped gap 105 is filled with the fine particles p.

Here, regarding the timing of the driving of the filling mechanism 106, the filling mechanism 106 may be driven in synchronization with the rotation of the application roller 110 in a case where the fine particle applying device 100 is driven, for example. However, for example, it is preferable that a state in which the wedge-shaped gap 105 is filled with the fine particles p is maintained in a case where the driving of the fine particle applying device 100 is started. In this case, for example, the filling mechanism 106 may apply a vibration force to the accommodation side plate 107 for a certain time as shown in FIG. 5C so that the wedge-shaped gap 105 is filled with the fine particles p in a case where an image forming operation of the image forming system 20 is finished as shown in FIG. 5B.

Note that the filling mechanism 106 is not limited to the rotation paddle 109 and modification of the design may be made like an aspect in which a vibration motor (not shown) is brought into direct or indirect contact with an outer side of the accommodation side plate 107 so that vibration is propagated and an aspect in which the outer side of the accommodation side plate 107 is pushed up by an eccentric cantilevered bar (not shown) and the cantilevered bar is rotated so that a tip end portion of the cantilevered bar repeatedly comes into contact with and is separated from the outer side of the accommodation side plate 107 to vibrate the accommodation side plate 107.

### Application Roller

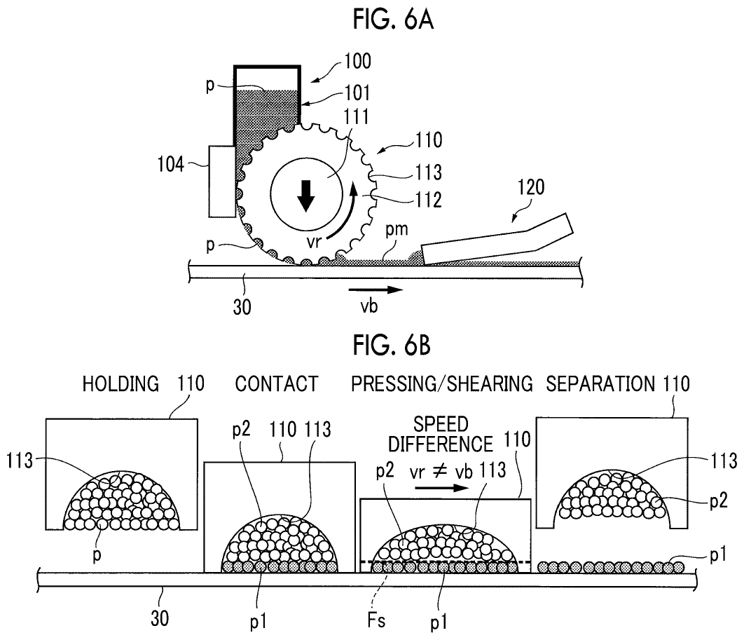

As shown in FIGS. 5A and 6A, the application roller 110 is an elastic roller that includes a large number of hemispherically concave cells 113 on a surface thereof and is obtained by stacking an elastic layer 112 formed of, for example, urethane foam or the like on a periphery of a roller body 111 formed of, for example, metal and forming the plurality of cells 113 on a surface of the elastic layer 112 through embossing.

In the present example, since the cells 113 of the application roller 110 need to hold the fine particles p therein, the cells 113 may be formed to have a diameter of, for example, 100 to 200 μm which is sufficiently larger than the particle size of the fine particles p.

In addition, in the present example, the application roller 110 is disposed to elastically come into contact with the restriction portion 104 of the application container 101. In addition, a distance of approximately 5 to 10 mm is selected as a distance d between the point of contact between the application roller 110 and the restriction portion 104 and a swing point (corresponding to a rotation fulcrum of the hinge 108) of the accommodation side plate 107.

Furthermore, the application roller 110 receives a drive force from a drive motor (not shown) to rotate in the same direction as a movement direction of the intermediate transfer body 30 at a position where the application roller 110 faces the intermediate transfer body 30. Here, it is necessary that vr≠vb at least, where vr is the rotation speed of the application roller 110 and vb is the rotation speed of the intermediate transfer body 30.

Hereinafter, how the application roller 110 is operated will be schematically described. In the present example, as shown in FIGS. 5A and 6A, in a case where the application roller 110 rotates with the wedge-shaped gap 105 filled with the fine particles p, since the application roller 110 is elastically pressed against the restriction portion 104 at the point of contact between the application roller 110 and the restriction portion 104, the restriction portion 104 crams the fine particles p into the cells 113 of the application roller 110 as much as the cells 113 can hold. As a result, as shown in “holding” in FIG. 6B, in the cell 113 of the application roller 110 that has passed through by the restriction portion 104, a large number of the fine particles p are held in a state where the cell 113 is filled with the fine particles p.

Next, in a case where the cell 113 of the application roller 110 that holds the fine particles p reaches a point of contact with the intermediate transfer body 30, as shown in “contact” in FIG. 6B, a group of fine particles p1, which is part of a group of the fine particles p in the cell 113 and is at a position facing an entrance, comes into contact with a surface of the intermediate transfer body 30.

In this state, since there is a speed difference between the rotation speed vr of the application roller 110 and the rotation speed vb of the intermediate transfer body 30, as shown in “pressing/shearing” in FIG. 6B, the group of fine particles p in the cell 113 is pressed against the intermediate transfer body 30 and the group of fine particles p1, which is a portion of the group of fine particles p in the cell 113 and is at the position facing the entrance, is caused to adhere to the surface of the intermediate transfer body 30. Therefore, a shearing force Fs accompanied by the speed difference acts at a boundary between the group of fine particles p1 at the position facing the entrance in the cell 113 and another group of fine particles p2 so that the group of fine particles p in the cell 113 is divided into two at the boundary.

Thereafter, in a case where the cell 113 of the application roller 110 that holds the group of fine particles p passes through the point of contact with the intermediate transfer body 30, as shown in “separation” in FIG. 6B, the cell 113 is moved to a position separated from the surface of the intermediate transfer body 30. At this time, the group of fine particles p1 at the position facing the entrance of the cell 113 is applied to a surface side of the intermediate transfer body 30 due to the adhesion force thereof and the other group of fine particles p2 in the cell 113 is left in the cell 113 in a state of being held in the cell 113.

### Leveling Member

In the present example, as shown in FIGS. 5A and 6A, the leveling member 120 is fixed to a portion of the application container 101 via a supporting bracket 121. The leveling member 120 is composed of an elastic plate-shaped member and is disposed such that a tip end portion thereof comes into contact with the intermediate transfer body 30 in a state of being inclined in a direction facing the movement direction of the intermediate transfer body 30. At this time, since the leveling member 120 needs to level the applied-fine-particle layer pm applied onto the intermediate transfer body 30 to be approximately even, an inclination angle β of the leveling member 120 at which the leveling member 120 is inclined with respect to a movement surface of the intermediate transfer body 30 is appropriately selected to fall within a range of 5 to 20 degrees.

As described above, in the present example, the applied-fine-particle layer pm that is applied onto the intermediate transfer body 30 by the application roller 110 is leveled by the leveling member 120 to be approximately even.

### Method of Detecting the State of Application of Fine Particles

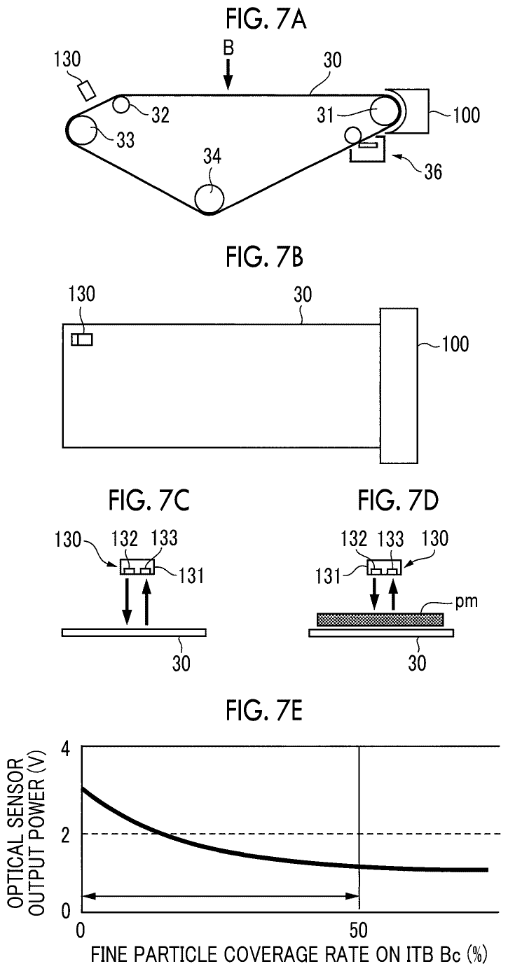

In the present example, an optical sensor 130 is provided as a detection unit that detects the state of application of the fine particles p on the intermediate transfer body 30. The optical sensor 130 may be disposed to face a surface of the intermediate transfer body 30 and as shown in FIGS. 7A and 7B, the optical sensor 130 is disposed close to an end portion of the intermediate transfer body 30 in an intersection direction that intersects the rotation direction of the intermediate transfer body 30 in a region between the tension rollers 32 and 33.

Here, as shown in FIG. 7C, the optical sensor 130 includes, for example, a light emitting element 132 and a light receiving element 133 in a sensor housing 131, a surface of the intermediate transfer body 30 is irradiated with light from the light emitting element 132, and light reflected from the intermediate transfer body 30 is detected by the light receiving element 133.

In the present example, in a state where the fine particles p have not been applied onto the intermediate transfer body 30, as shown in FIG. 7C, the optical sensor 130 detects light reflected from the intermediate transfer body 30 by means of the light receiving element 133. Meanwhile, in a state where the fine particles p have been applied onto the intermediate transfer body 30, as shown in FIG. 7D, the optical sensor 130 detects light reflected from the applied-fine-particle layer pm on the intermediate transfer body 30 by means of the light receiving element 133.

Here, as a result of examination of a relationship between a fine particle coverage rate Bc (%) on the intermediate transfer body 30 and output power (V) of the optical sensor 130, a tendency as follows has been observed. An optical sensor of a wavelength of 940 nm was used as the optical sensor 130 and SiO₂ having a particle size of 115 nm was used as a fine particle.

In this case, as shown in FIG. 7E, the output power of the optical sensor 130 has a tendency to be maximized in a state where the fine particles p have not been applied and to gradually decrease as the fine particle coverage rate Bc increases. At this time, in a case where the fine particle coverage rate Bc is equal to or larger than 10%, it is possible to clearly determine that the fine particles p have been applied since the output power of the optical sensor 130 decreases to be equal to or smaller than two-thirds of the output power exerted in a case where the fine particles p have not been applied.

However, in the present example, in a case where the fine particle coverage rate Bc exceeds 50%, a rate at which the output power of the optical sensor 130 decreases is made extremely small, so that the output power of the optical sensor 130 is made approximately equal to the output power exerted in a case where the fine particle coverage rate Bc is 50%. It is presumed that this is because reflection output power decreases due to diffused reflection and an light confinement effect caused by fine particles in a case where the fine particle coverage rate Bc increases.

Note that in the present example, the output power of the optical sensor 130 corresponds to the output power of the light receiving element 133 and the fine particle coverage rate Bc means a rate at which the fine particles p occupy a predetermined reference region regarding the applied-fine-particle layer pm applied onto the intermediate transfer body 30.

Therefore, in the present example, since the output power of the optical sensor 130 that is exerted in a state where the fine particles p have been applied is lower than the output power of the optical sensor 130 that is exerted in a state where the fine particles p have not been applied, it is possible to determine whether or not the fine particles p have been applied onto the intermediate transfer body 30 by checking the output power of the optical sensor 130.

Particularly, in consideration of the output characteristics of the optical sensor 130, for example, it is preferable to select the fine particle coverage rate Bc in a range of 10 to 50% in a case where the applied-fine-particle layer pm is to be formed.

### Relationship Between Fine Particle Coverage Rate and Toner Adhesion Force

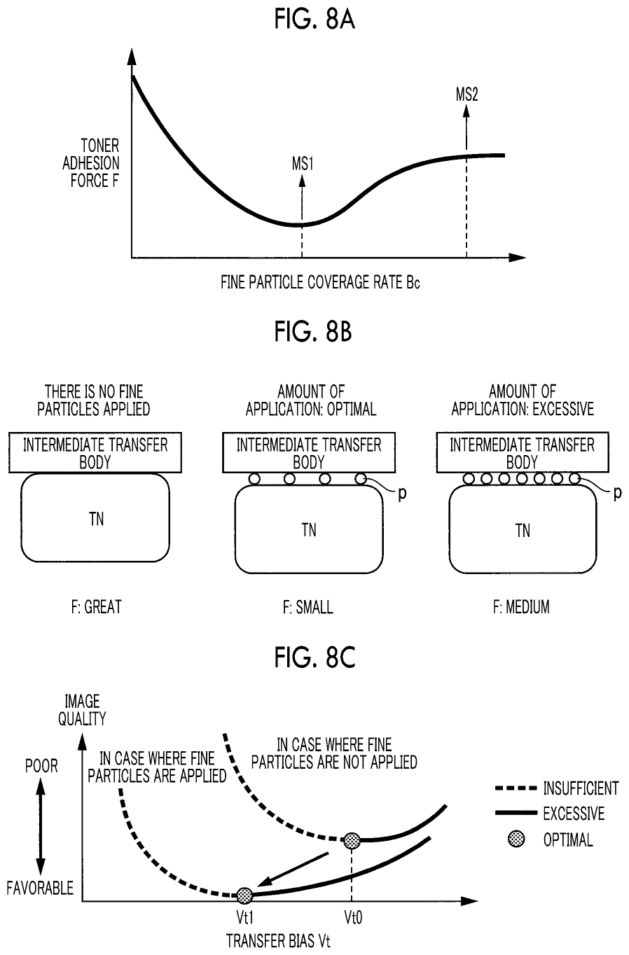

In the present example, as a result of examination of a relationship between the fine particle coverage rate Bc and a toner adhesion force F, it has been found that the toner adhesion force F has a tendency to be maximized in a case where fine particles are not applied and to gradually decrease as the fine particle coverage rate Bc increases until the fine particle coverage rate Bc becomes equal to or larger than a certain rate as shown in FIG. 8A. However, the toner adhesion force F has a tendency to increase again in a case where the fine particle coverage rate Bc becomes equal to or larger than the certain rate. It is presumed that this is because, in a case where the fine particle coverage rate Bc becomes equal to or larger than the certain rate, the number of points of contact between the fine particles p and toner TN is increased and the toner adhesion force F is also increased as the van der Waals force increases as in the case of an excessive amount of application shown in FIG. 8B.

Therefore, in the present example, as shown in FIG. 8A, the fine particle coverage rate Bc close to a minimum value at which the toner adhesion force F is minimized is selected so that the amount of applied fine particles is optimized. Note that it is a matter of course that a fine particle coverage rate different from the fine particle coverage rate in the present example may be selected as the fine particle coverage rate Bc.

### Relationship Between Whether or not Fine Particles are Applied and Transfer Bias

Furthermore, in the present example, since the toner adhesion force F is different between a case where the fine particles are applied and a case where the fine particles are not applied, the transfer bias Vt of the transfer device 50 is selected to be different depending on whether or not the fine particles are applied.

For example, in a case where the fine particles are not applied, the image G formed of the toner TN is held on the intermediate transfer body 30 as shown in FIG. 4B. As a result of examination on whether or not an image quality is favorable that is performed in this state while changing the transfer bias Vt, as shown in FIG. 8C, it has been found that the image quality has a tendency to be most favorable in a case where the transfer bias Vt is Vt0 and to deteriorate in both a case where the transfer bias Vt is set to be larger than Vt0 and a case where the transfer bias Vt is set to be smaller than Vt0.

In addition, in a case where the fine particles p are applied at the fine particle coverage rate Bc determined in advance, the image G formed of the toner TN is held on the intermediate transfer body 30 via the applied-fine-particle layer pm as shown in FIG. 4C. As a result of examination whether or not an image quality is favorable that is performed in this state while changing the transfer bias Vt, it has been found that the image quality has a tendency to be most favorable in a case where the transfer bias Vt is Vt1 (<Vt0) and to deteriorate in both a case where the transfer bias Vt is set to be larger than Vt1 and a case where the transfer bias Vt is set to be smaller than Vt1. However, it has been confirmed that the image quality achieved in a case where the fine particles are applied and a transfer bias Vt0 to be adopted in a case where the fine particles are not applied is selected is more favorable than the image quality achieved in a case where the fine particles are not applied.

Therefore, regarding the transfer bias Vt to be adopted in a case where the fine particles are applied, unlike the transfer bias Vt0 to be adopted in a case where the fine particles are not applied, a transfer bias Vt1 at which the image quality is most favorable in a case where the fine particles are applied is selected.

### Control System

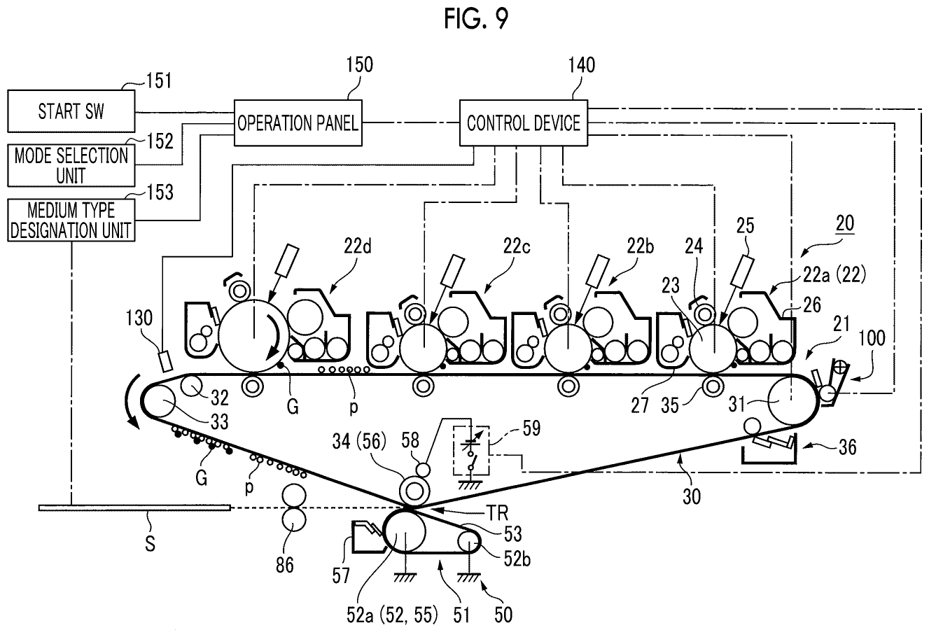

In the present exemplary embodiment, a control system of the image forming system 20 includes a control device 140 composed of a microcomputer including various processors, as shown in FIG. 9. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

An operation panel 150 of the image forming system 20 and the optical sensor 130 are connected to the control device 140. In addition, the control device 140 and each of targets to be controlled (each image forming unit 22, the intermediate transfer body 30, the transfer power source 59 of the transfer device 50, the fine particle applying device 100, and the like) are connected to each other.

Furthermore, the operation panel 150 is provided with a start switch (written as “START SW” in FIG. 9) 151 for start of an image forming process performed by the image forming system 20, a mode selection unit 152 for selection of various image forming modes (a single-sided/two-sided printing mode, a standard/high-quality printing mode, and the like), and a medium type designation unit 153 for designation of the type (the resistance, the thickness, the weight, the size, presence or absence of an embossment, or the like) of the medium S. Note that regarding the type of the medium S, for example, it is a matter of course that a detector that detects the type of the medium S (the resistance, the thickness, the weight, the size, presence or absence of an embossment, or the like) may be installed in the medium supply container 81 or in the middle of a transport path so that the type of the medium S is acquired by means of the detector.

### Image Forming Process of Image Forming System

Next, how an image forming process is performed by an image forming apparatus according to the present exemplary embodiment will be described.

First, as shown in FIG. 9, when an operation of turning on the start switch 151 is performed, the image forming system 20 starts a printing job based on an image forming mode selected by means of the mode selection unit 152. In this state, the medium S is supplied from the medium supply container 81 while an image forming process for each color component image to be transferred to the medium S is performed at the image forming units 22. Then, color component images formed in such a way are moved to the transfer region TR via the intermediate transfer body 30.

Thereafter, the medium S is transported to the transfer region TR through the horizontal transport path 83 and a transfer operation is performed by the transfer device 50. Then, the medium S with each color component image transferred thereto passes through the fixing device 70 and an image is fixed onto the medium S.

### Fine Particle Application Control Process

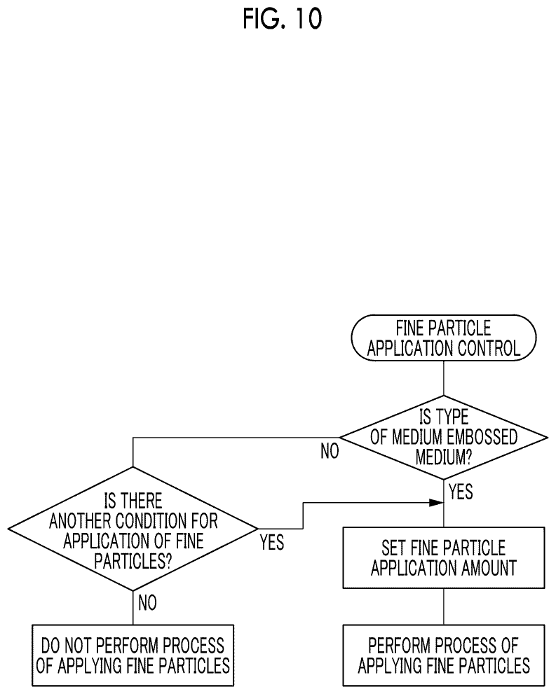

In the present example, the control device 140 executes a fine particle application control program shown in FIG. 10 to control an operation of applying the fine particles p onto the intermediate transfer body 30.

In the drawing, first, the control device 140 determines whether or not the medium S is an embossed medium based on instruction information from the medium type designation unit 153. Then, in a case where the medium S is an embossed medium, a fine particle application amount is set and a process of applying the fine particles p by means of the fine particle applying device 100 is performed. Here, the fine particle application amount to be set may be selected as appropriate. However, in the present example, as shown in FIGS. 8A and 8B, the fine particle coverage rate Bc close to the minimum value (corresponding to an optimal fine particle application amount) at which the toner adhesion force F is minimized is selected.

In addition, in a case where the medium S is not an embossed medium and there is another condition for application of the fine particles, a process of applying the fine particles p is performed after the fine particle application amount is set to be appropriate for the other condition. Meanwhile, in a case where the medium S is not an embossed medium and there is no other condition for application of the fine particles, the process of applying the fine particles p may not be performed.

Here, examples of the other condition for application of the fine particles include a condition in which a type of paper of which the basis weight is high, that is bulky, and with which sufficient transferability cannot be achieved or rough paper of which paper fibers are exposed to a large degree is used. Note that rough paper in the present example refers to paper that does not have unevenness (of about 30 μm or more) attributable to embossing but is coarser than, for example, electrophotographic paper (having unevenness of about 10 to 30 μm).

### Bias Control Process of Transfer Device

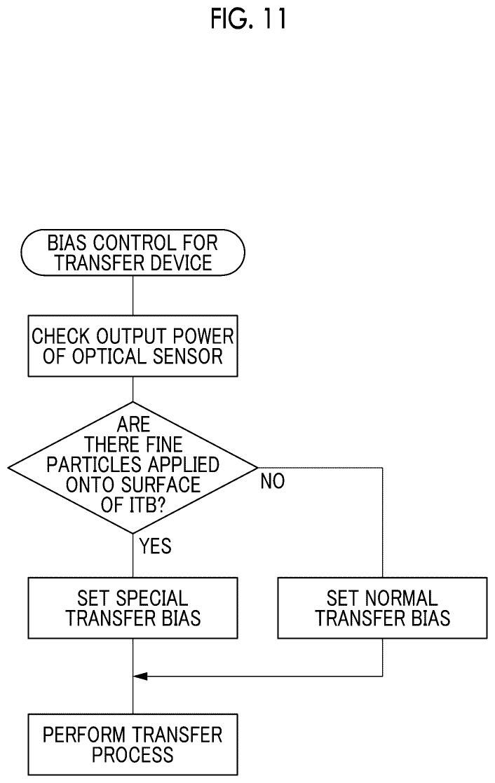

The control device 140 executes a transfer device bias control program shown in FIG. 11 to control the transfer bias Vt applied to the transfer device 50 and to cause the transfer device 50 to perform a transfer process.

In the drawing, the control device 140 checks the output power of the optical sensor 130 shown in FIG. 9 to determine whether or not the fine particles p have been applied to a surface of the intermediate transfer body 30 (written as “ITB” in FIG. 11).

Here, in a case where the fine particles p have not been applied, the normal transfer bias Vt0 to be adopted in the case of a normal image forming mode is set and the transfer device 50 is caused to perform the transfer process.

Meanwhile, in a case where the fine particles p have been applied, a special transfer bias Vt1 (<Vt0) to be adopted in the case of a special image forming mode is set and the transfer device 50 is caused to perform the transfer process.

### Operation of Image Forming System

Normal Image Forming Mode (Image Forming Mode I)

In the present example, the image forming system 20 executes a normal image forming mode (an image forming mode I) on a condition in which the fine particles p are not applied to the intermediate transfer body 30.

In the normal image forming mode (the image forming mode I), as shown in FIGS. 2 and 4B, the images G of color components respectively formed by the image forming units 22 (22a to 22d) are sequentially primarily transferred onto the intermediate transfer body 30 with no fine particles p applied thereto and are secondarily transferred to the medium S (in the present example, the normal medium Sa is used) by the transfer device 50 in the transfer region TR.

In the present example, as shown in FIG. 4B, the normal transfer bias Vt0 is applied to the transfer device 50 and the transfer electric field Ea formed by the normal transfer bias Vt0 is formed in the transfer region TR so that the image G is transferred to the normal medium Sa.

### Special Image Forming Mode (Image Forming Mode II)

In the present example, the image forming system 20 executes a special image forming mode (an image forming mode II), which is a mode obtained by adding a process of applying the fine particles p to the normal image forming mode, on a condition in which the fine particles p are applied to the intermediate transfer body 30.

In the special image forming mode (the image forming mode II), as shown in FIGS. 2 and 4C, the fine particle applying device 100 applies the fine particles p over the entire intermediate transfer body 30 based on the fine particle coverage rate Bc determined in advance and then the image forming units 22 (22a to 22d) sequentially primarily transfer the images G of respective color components onto the intermediate transfer body 30. Therefore, the images G of the respective color components formed by the image forming units 22 are held on the applied-fine-particle layer pm on the intermediate transfer body 30 and are secondarily transferred to the medium S (in the present example, the embossed medium Sb) in the transfer region TR.

At this time, since the images G of the respective color components on the intermediate transfer body 30 are held via the applied-fine-particle layer pm, the images G can be easily transferred to the embossed medium Sb(S) and the images G of the respective color components are appropriately transferred without being influenced by unevenness of the embossed medium Sb.

Particularly, in the present example, the special transfer bias Vt1 appropriate for a transfer condition for a case where the fine particles are applied is set instead of the normal transfer bias Vt0 for the normal image forming mode as the transfer bias Vt used for the transfer device 50. Therefore, the transfer electric field Eb (Eb<Ea) formed by the special transfer bias Vt1 is formed in the transfer region TR and image transferability of a higher image quality can be obtained in comparison with a case where the normal transfer bias Vt0 is used.

### Other Configuration Examples of Fine Particle Applying Device

In the present exemplary embodiment, for example, the fine particle applying device 100 is not limited to the aspects disclosed in the first exemplary embodiment, and it is a matter of course that design changes can be made as appropriate as in the case of aspects in Modification Exemplary Embodiment 1-1 and Modification Exemplary Embodiment 1-2.

### Modification Exemplary Embodiment 1-1

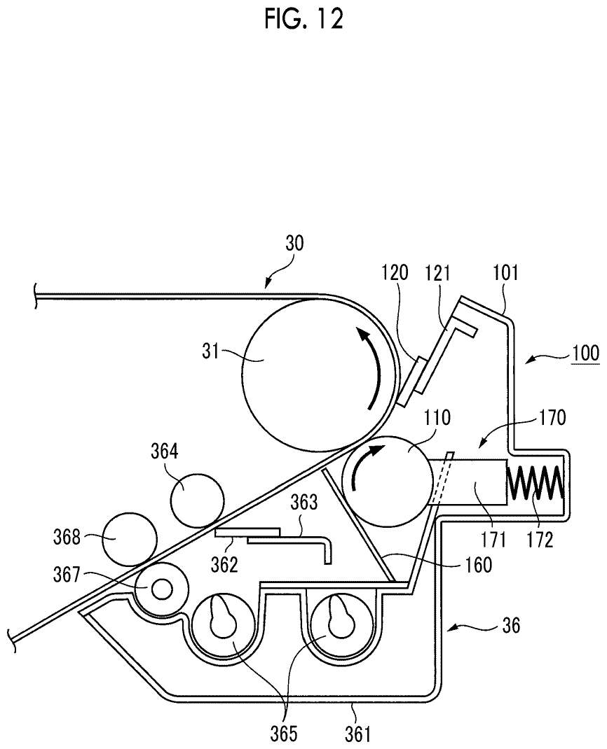

FIG. 12 shows a fine particle applying device according to Modification Exemplary Embodiment 1-1.

In the drawing, the fine particle applying device 100 has a configuration different from the configuration in Exemplary Embodiment 1 and is integrally incorporated into the intermediate transfer body cleaning device 36.

In the present example, the intermediate transfer body cleaning device 36 is provided upstream of the tension roller 31 in the rotation direction while being provided close to the tension roller 31 of the intermediate transfer body 30. The intermediate transfer body cleaning device 36 includes the cleaning housing 361 with the opening that faces the surface of the intermediate transfer body 30, the elastic plate-shaped cleaning member 362 is provided at the edge of the opening of the cleaning housing 361 via the supporting bracket 363, and the facing roller 364 is provided at the inner surface of the intermediate transfer body 30 that faces the cleaning member 362. Furthermore, in the present example, a pair of the leveling and transporting members 365 that levels and transports accommodated residue is provided in a lower portion of the cleaning housing 361, a brush-shaped second cleaning member 367 is provided upstream of the plate-shaped cleaning member 362 in the rotation direction of the intermediate transfer body 30, and a facing roller 368 is provided at an inner surface of the intermediate transfer body 30 that faces the second cleaning member 367.

In addition, the fine particle applying device 100 is incorporated into an upper portion of the cleaning housing 361 of the intermediate transfer body cleaning device 36.

In the present example, as with Exemplary Embodiment 1, the fine particle applying device 100 includes the application container 101 with the opening that faces a portion of the intermediate transfer body 30 that is looped over the tension roller 31, the application roller 110 that is disposed to face the opening of the application container 101 and that comes into contact with the intermediate transfer body 30 to apply the fine particles p, the plate-shaped leveling member 120 that makes the amount of application even over the applied-fine-particle layer pm applied to the intermediate transfer body 30, and a fine particle adhesion mechanism 170 that causes the fine particles p to adhere to a surface of the application roller 110.

In the present example, unlit Exemplary Embodiment 1, the application container 101 is integrally formed with the upper portion of the cleaning housing 361 and a partition member 160 is provided between the application roller 110 and the cleaning member 362. In addition, the application roller 110 is configured in substantially the same manner as in Exemplary Embodiment 1. Furthermore, the leveling member 120 is supported by an upper edge portion of the opening of the application container 101 via the supporting bracket 121, and is configured in substantially the same manner as in Exemplary Embodiment 1.

Particularly, in the present example, the fine particle adhesion mechanism 170 brings a block-shaped fine particle solid mass 171 produced through compression molding of a large number of fine particles into contact with the application roller 110 on a side opposite to a point of contact between the application roller 110 and the intermediate transfer body 30 and presses the fine particle solid mass 171 against a surface of the application roller 110 by means of a pressing spring 172 serving as a pressing unit. In the case of the fine particle adhesion mechanism 170, the fine particles p are chipped out from the fine particle solid mass 171 at a point of contact between the application roller 110 and the fine particle solid mass 171 as the application roller 110 rotates, are crammed into concave cells (not shown) of the application roller 110 as much as the cells can hold, and adhere to the surface of the application roller 110.

As a result, the application roller 110 reaches the point of contact with the intermediate transfer body 30 in a state where the fine particles p are held at the surface thereof and after the fine particles p are applied to a surface of the intermediate transfer body 30, the leveling member 120 levels the fine particles p to achieve a predetermined amount of application. Note that in the present example, even in a case where a portion of the fine particles p chipped out from the point of contact between the fine particle solid mass 171 and the application roller 110 falls, the portion of the fine particles p is accumulated in a space partitioned by the partition member 160.

In addition, in the present example, the fine particle applying device 100 does not include the application container 101 (the accommodation portion 102 in which powdery fine particles are accommodated, the wedge-shaped gap 105 formed between the application roller 110 and the restriction portion 104, and the filling mechanism 106) in Exemplary Embodiment 1. However, the application container 101 in Exemplary Embodiment 1 may be used such that the fine particle solid mass 171 (refer to FIG. 12) is disposed in the accommodation portion 102 to come into contact with the application roller 110 or a chipping roller (not shown) provided separately from the application roller 110, the fine particles p are chipped out from the fine particle solid mass 171 by the application roller 110 or the chipping roller, and the wedge-shaped gap 105 is filled with the chipped-out powdery fine particles p.

### Modification Exemplary Embodiment 1-2

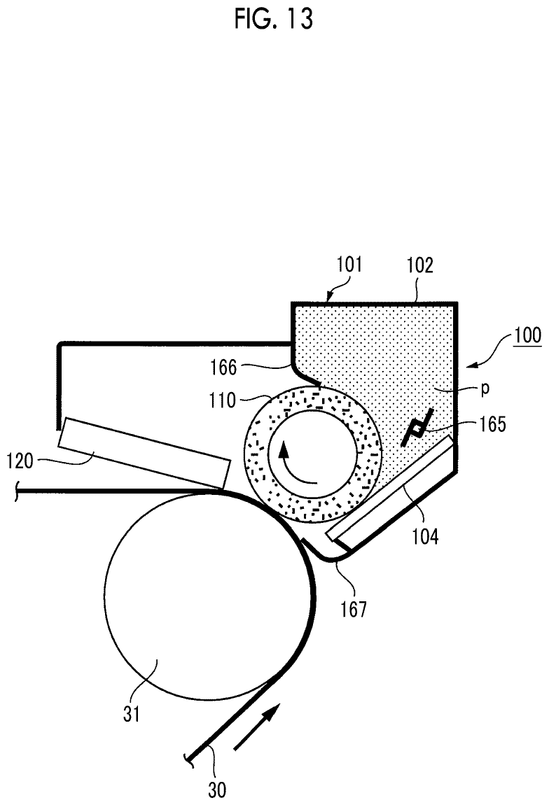

FIG. 13 shows a fine particle applying device according to Modification Exemplary Embodiment 1-2.

In the drawing, as with Exemplary Embodiment 1, the fine particle applying device 100 includes the application container 101 in which the powdery fine particles p are accommodated, the application roller 110 that applies the fine particles p to the intermediate transfer body 30, and the leveling member 120 that levels the applied-fine-particle layer pm applied to the intermediate transfer body 30. However, the layout of the application roller 110 and the leveling member 120 and a method causing the fine particles p to adhere to the application roller 110 are different from the layout and the method in Exemplary Embodiment 1.

In the present example, the application roller 110 and the leveling member 120 are disposed above a portion of the intermediate transfer body 30 that is looped over the tension roller 31.

In addition, the application container 101 includes the accommodation portion 102 that is open to cover the right half surface of the application roller 110 in the drawing and in which the powdery fine particles p are accommodated, the restriction portion 104 that comes into contact with the application roller 110 is provided close to a lower portion of the application roller 110 in the accommodation portion 102, and the wedge-shaped gap 105 is formed between the restriction portion 104 and the application roller 110. In addition, an agitator 165 serving as a agitating member that agitates the accumulated fine particles p is provided above the wedge-shaped gap 105 in the accommodation portion 102. Note that an upper edge of an opening of the accommodation portion 102 of the application container 101 is provided with an upper seal member 166 that elastically comes into contact with an upper portion of the application roller 110 to perform sealing and a lower edge of the opening of the accommodation portion 102 is provided with a lower seal member 167 that elastically comes into contact with a surface of the intermediate transfer body 30 to perform sealing.

As described above, according to the present example, the application roller 110 and the agitator 165 may be rotated as the intermediate transfer body 30 rotates in a case where the fine particles p are to be applied to the intermediate transfer body 30. At this time, in the accommodation portion 102 of the application container 101, the wedge-shaped gap 105 side is filled with the fine particles p in the accommodation portion 102 due to the rotation of the agitator 165 and in a case where the application roller 110 rotates in such a state, the restriction portion 104 crams the fine particles p into the cells (not shown) of the application roller 110 as much as the cells can hold at the point of contact between the application roller 110 and the restriction portion 104. As a result, the application roller 110 reaches the point of contact with the intermediate transfer body 30 in a state where the fine particles p are held at the surface thereof and after the fine particles p are applied to a surface of the intermediate transfer body 30, the leveling member 120 levels the fine particles p to achieve a predetermined amount of application.

### Exemplary Embodiment 2

The image forming system 20 according to Exemplary Embodiment 2 is an image forming system obtained by applying the present invention to an aspect in which the amount of application of fine particles to be applied to the intermediate transfer body 30 is changed in a plurality of steps. Basically, the image forming system 20 according to Exemplary Embodiment 2 has the same configuration as the configuration in Exemplary Embodiment 1 but fine particle application control with respect to the intermediate transfer body 30 and bias control of the transfer device 50 are different from fine particle application control and bias control in Exemplary Embodiment 1.

### Fine Particle Application Control Process

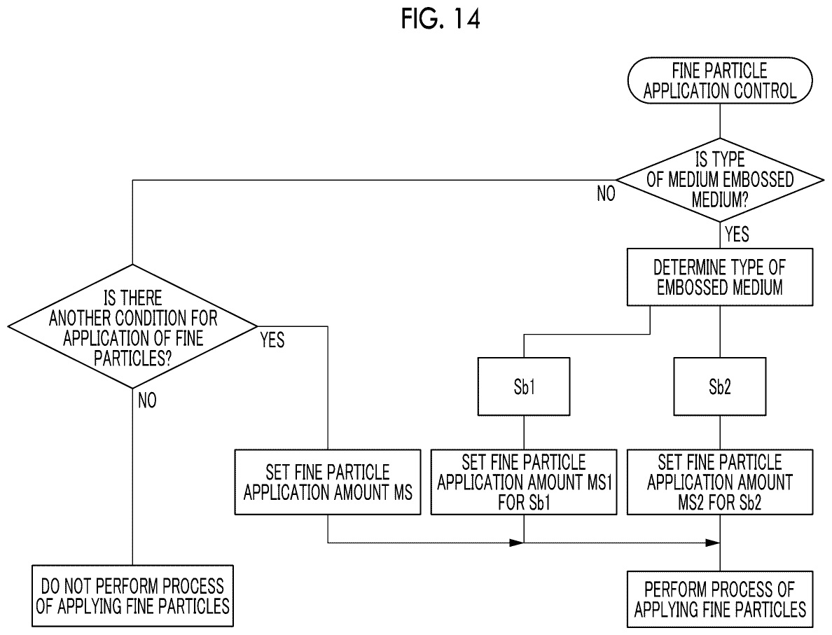

In the present example, the control device 140 (refer to FIG. 9) executes a fine particle application control program shown in FIG. 14 to control an operation of applying the fine particles p onto the intermediate transfer body 30.

In the drawing, first, the control device 140 determines whether or not the medium S is the embossed medium Sb based on instruction information from the medium type designation unit 153 (refer to FIG. 9). At this time, in a case where there are a plurality of types of embossed mediums depending on the depth and the size of an embossment, the type (for example, Sb1 and Sb2) of each embossed medium is determined.

Then, in a case where the medium S is the embossed medium Sb, a fine particle application amount MS (MS1 and MS2) is set depending on the type (Sb1 and Sb2) of the embossed medium and a process of applying the fine particles p by means of the fine particle applying device 100 is performed.

Here, the fine particle application amount MS to be set may be selected as appropriate. However, in the present example, as shown in FIG. 8A, based on the relationship between the fine particle coverage rate Bc on the intermediate transfer body 30 and the toner adhesion force F, a fine particle application amount MS1 is set close to the fine particle coverage rate Bc at which the toner adhesion force F is minimized and a fine particle application amount MS2 is set to the fine particle coverage rate Bc selected from a range in which the toner adhesion force F increases again after being minimized, so that a relationship of MS1<MS2 is satisfied.

In addition, in a case where the fine particle application amount MS is to be changed, for example, a rotation speed vr of the application roller 110 may be changed relative to a rotation speed vb of the intermediate transfer body 30 so that the speed difference is changed and the amount of application performed by the application roller 110 with respect to the intermediate transfer body 30 is changed.

Furthermore, in a case where the medium S is not the embossed medium Sb, it is determined whether or not there is another condition for application of the fine particles and in a case where there is the other condition for application of the fine particles, a process of applying the fine particles p is performed after the fine particle application amount is set to be appropriate for the other condition. Meanwhile, in a case where the medium S is not the embossed medium Sb and there is no other condition for application of the fine particles, the process of applying the fine particles p may not be performed.

### Bias Control Process of Transfer Device

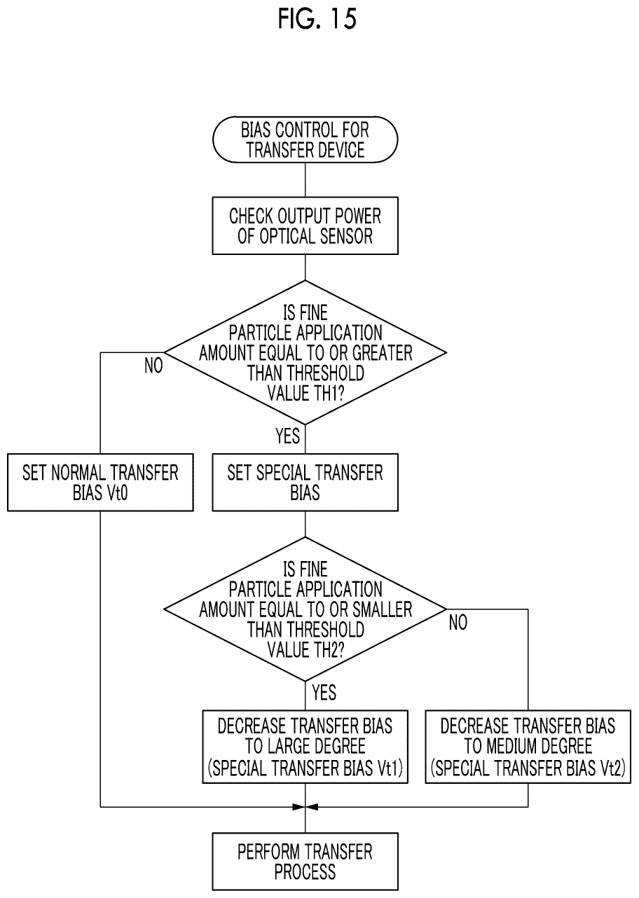

The control device 140 (refer to FIG. 9) executes a transfer device bias control program shown in FIG. 15 to control the transfer bias Vt applied to the transfer device 50 based on whether the fine particle application amount on the intermediate transfer body 30 is large or small and to cause the transfer device 50 to perform a transfer process.

In the drawing, the control device 140 checks the output power of the optical sensor 130 shown in FIG. 9 to determine whether or not the fine particles p have been applied to a surface of the intermediate transfer body 30 and which range the amount of application of the fine particles p belongs to.

In Exemplary Embodiment 1, it has been found that, in a case where the fine particles p have been applied, the special transfer bias Vt1 for the transfer device 50 can be lower than the normal transfer bias Vt0 to be adopted in a case where the fine particles p have not been applied.

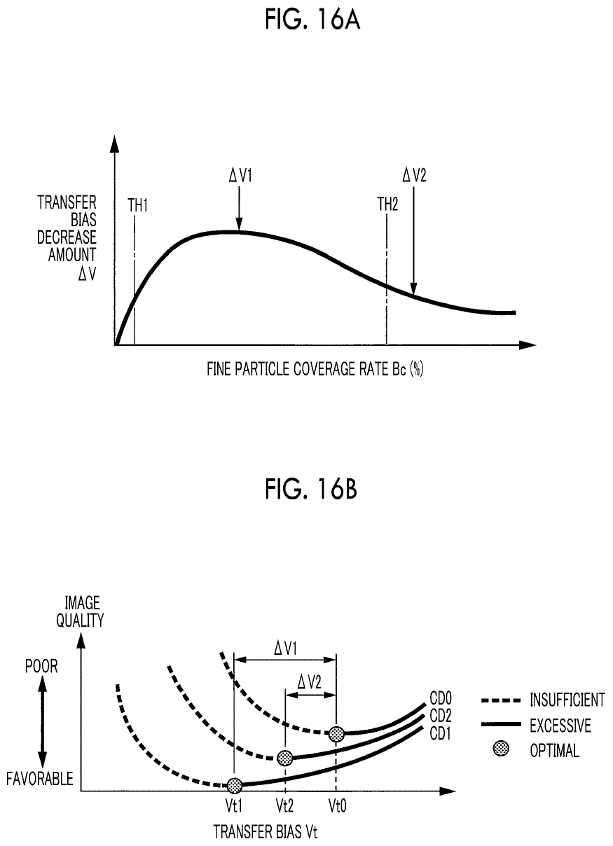

Therefore, in the present example, through examination of a relationship between the fine particle coverage rate Bc (%) and a decrease amount ΔV of the transfer bias Vt, a result as shown in FIG. 16A has been obtained.

In the drawing, it has been found that the decrease amount ΔV of the transfer bias Vt has a tendency to reach a maximum decrease amount ΔV1 after rapidly increasing and to gently decrease thereafter to converge to a value close to ΔV2 (<ΔV1) as the fine particle coverage rate Bc gradually increases from a time when the fine particles are not yet applied.

Here, a value of the fine particle coverage rate Bc for clearly determining whether or not the fine particles p have been applied onto the intermediate transfer body 30 is set as a first threshold value TH1 and a value of the fine particle coverage rate Bc at which the fine particle application amount on the intermediate transfer body 30 is excessive and the decrease amount ΔV of the transfer bias Vt is closer to ΔV2 than to ΔV1 is set as a second threshold value TH2.

In addition, in the present example, the fine particle application amounts MS1 and MS2 are selected to satisfy a relationship of TH1<MS1<TH2<MS2.

In addition, it is determined based on the output power of the optical sensor 130 whether or not a fine particle application amount is equal to or larger than the threshold value TH1.

At this time, in a case where the fine particle application amount is smaller than the threshold value TH1, it is determined that the fine particles p have not been applied or a very small amount of the fine particles p has been applied even in a case where the fine particles p have been applied. Therefore, the transfer power source 59 of the transfer device 50 sets the normal transfer bias Vt0 as the normal image forming mode and applies the normal transfer bias Vt0 to the transfer region TR.

In addition, in a case where the fine particle application amount is equal to or larger than the threshold value TH1 and is smaller than the threshold value TH2, the transfer power source 59 of the transfer device 50 sets the special transfer bias Vt1 as the special image forming mode and applies the special transfer bias Vt1 to the transfer region TR.

Furthermore, in a case where the fine particle application amount is equal to or larger than the threshold value TH2, the transfer power source 59 of the transfer device 50 sets a special transfer bias Vt2 as the special image forming mode and applies the special transfer bias Vt2 to the transfer region TR.

Here, supplementary description about the setting of the special transfer biases Vt1 and Vt2 is as follows.

Through examination of whether or not an image quality is favorable that is performed while changing the transfer bias Vt regarding a case where the fine particles are not applied (CD0), the case of the fine particle application amount MS1 (CD1), and the case of the fine particle application amount MS2 (CD2) as the state of application of the fine particles p on the intermediate transfer body 30, a result as shown in FIG. 16B has been obtained.

In the drawing, it has been found that, in a case where the fine particles are not applied (CD0), the image quality has a tendency to be most favorable in a case where the transfer bias Vt is Vt0 and to deteriorate in both a case where the transfer bias Vt is set to be larger than Vt0 and a case where the transfer bias Vt is set to be smaller than Vt0.

In addition, it has been found that, in the case of the fine particle application amount MS1 (CD1), the image quality has a tendency to be most favorable in a case where the transfer bias Vt is Vt1 (<Vt0) and to deteriorate in both a case where the transfer bias Vt is set to be larger than Vt1 and a case where the transfer bias Vt is set to be smaller than Vt1. In the present example, as shown in FIGS. 16A and 16B, the special transfer bias Vt1 is selected as a value lower than the normal transfer bias Vt0 by the decrease amount ΔV1.

Furthermore, it has been found that, in the case of the fine particle application amount MS2 (CD2), the image quality has a tendency to be most favorable in a case where the transfer bias Vt is Vt2 (>Vt1) and to deteriorate in both a case where the transfer bias Vt is set to be larger than Vt2 and a case where the transfer bias Vt is set to be smaller than Vt2. In the present example, as shown in FIGS. 16A and 16B the special transfer bias Vt2 is selected as a value lower than the normal transfer bias Vt0 by a decrease amount ΔV2.

In the present example, in both the case of CD1 and the case of CD2, the image G formed of the toner TN is held on the intermediate transfer body 30 via the applied-fine-particle layer pm.

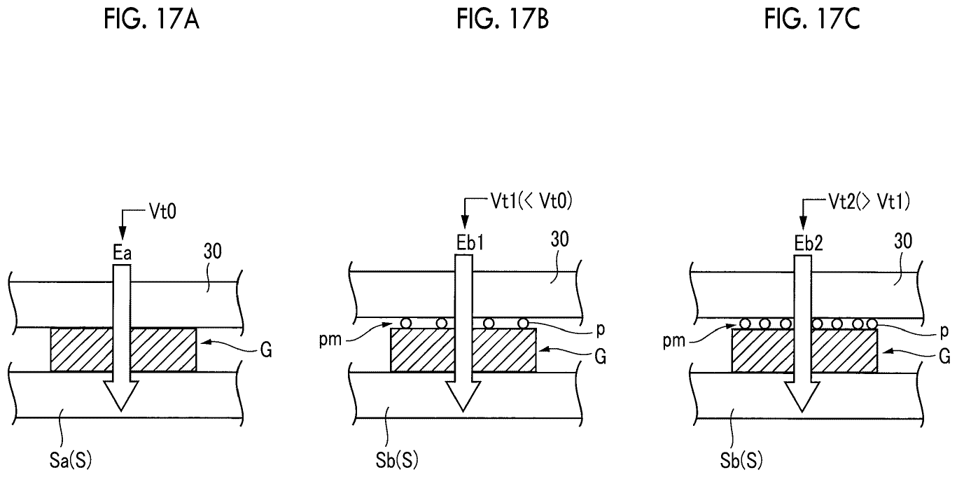

However, CD1 is the case of the fine particle application amount MS1 and as shown in FIGS. 8A and 8B, CD1 corresponds to the fine particle coverage rate Bc close to the minimum value at which the toner adhesion force F is minimized. Therefore, as shown in FIGS. 17A and 17B, the special transfer bias Vt1 in the case of CD1 is set to be lower than the normal transfer bias Vt0. Accordingly, a transfer electric field Eb1 formed by the special transfer bias Vt1 is formed to be weaker than the transfer electric field Ea formed by the normal transfer bias Vt0.

Meanwhile, CD2 is the case of the fine particle application amount MS2 and as shown in FIGS. 8A and 8B, CD2 corresponds to the fine particle coverage rate Bc at which the number of points of contact between the fine particles p and the toner TN is increased and the toner adhesion force F is increased again as the van der Waals force increases as a result of an excessive amount of application of the fine particles p. Therefore, as shown in FIGS. 17A to 17C, the special transfer bias Vt2 in the case of CD2 is set to be lower than the normal transfer bias Vt0 and to be higher than the special transfer bias Vt1. Accordingly, a transfer electric field Eb2 formed by the special transfer bias Vt2 is formed to be weaker than the transfer electric field Ea formed by the normal transfer bias Vt0 and to be stronger than the transfer electric field Eb1 formed by the special transfer bias Vt1.

As described above, according to the present exemplary embodiment, even in a case where there is a difference in fine particle application amount on the intermediate transfer body 30 in a special image forming mode, the special transfer biases Vt1 and Vt2 appropriate for each fine particle application amount are set and image transferability of a high image quality can be secured because of the transfer electric field Eb (Eb1 and Eb2) formed by each of the transfer biases Vt1 and Vt2.

Note that, in the present exemplary embodiment, the special transfer biases Vt1 and Vt2 are changed stepwise in two steps. However, the present invention is not limited thereto, the special transfer biases Vt1 and Vt2 may be changed stepwise in, for example, three or more steps and it is a matter of course that a special transfer bias may be continuously changed along a change curve of the transfer bias decrease amount with respect to the fine particle coverage rate as shown in FIG. 16A.

### Exemplary Embodiment 3

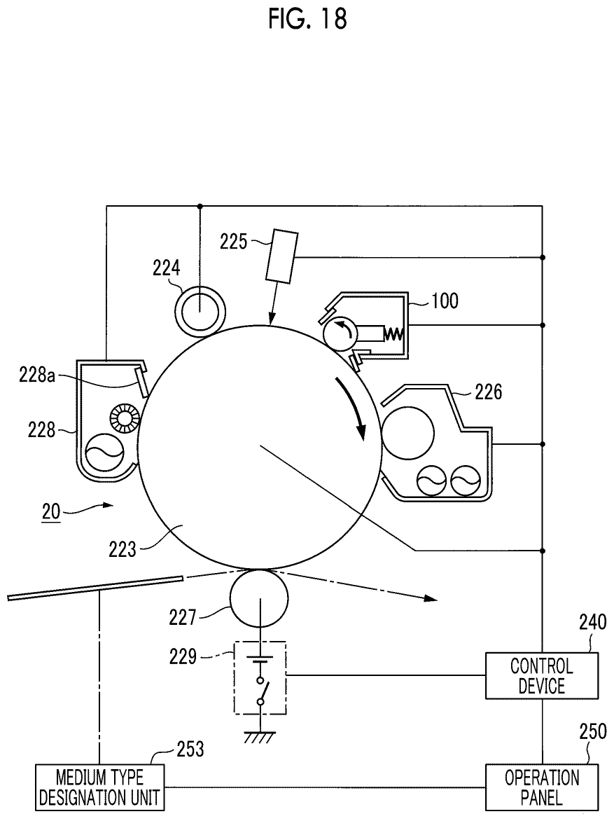

FIG. 18 shows a major part of an image forming system according to Exemplary Embodiment 3.

In the drawing, unlike Exemplary Embodiments 1 and 2, the image forming system 20 forms a monochromatic image formed of black toner, for example.

In the drawing, an electrophotographic type image forming system is adopted as the image forming system 20 and the image forming system 20 includes a drum-shaped photoconductor 223 and an around the photoconductor 223, a charging device 224 at which the photoconductor 223 is charged, an optical writing device 225 at which an electrostatic latent image is written on the charged photoconductor 223, a development device 226 at which the electrostatic latent image written on the photoconductor 223 is developed by each color component toner, a transfer device 227 at which a toner image formed on the photoconductor 223 is transferred to the medium S, and a cleaning device 228 (including a plate-shaped cleaning member 228a) at which the toner TN remaining on the photoconductor 223 is removed are disposed.

In addition, in the present example, the fine particle applying device 100 is provided between the optical writing device 225 and the development device 226 in the vicinity of the photoconductor 223 so that fine particles are applied onto the photoconductor 223 in a case where the medium S is an embossed medium, for example.

In the present example, an operation panel 250 is connected to a control device 240 and a medium type designation unit 253 or the like is connected to the operation panel 250. In addition, the control device 240 performs a process of controlling application of fine particles to the photoconductor 223 in addition to a normal image forming control process so as to appropriately control the photoconductor 223 and each device around the photoconductor 223.

Note that a reference numeral “229” denotes a transfer power source of the transfer device 227.

In the present example, the control device 240 performs application control of fine particles with respect to the photoconductor 223 and performs a transfer bias control process of the transfer device 227 depending on the state of application of the fine particles. The transfer bias control process of the transfer device 227 mentioned herein is performed in substantially the same manner as in Exemplary Embodiments 1 and 2.

In addition, although described in the present example is an image forming system that forms a monochromatic image, the image forming system 20 of the present example may also be applied to an image forming system in which the image forming units 22 (22a to 22d (refer to FIG. 2)) of respective color components are disposed to face a medium transport belt that transports the medium S, for example.

### Examples

In present Example, a device based on Revoria Press PC1120 manufactured by FUJIFILM Business Innovation Corp. was used. An evaluation was performed at 22° C./55%, and the process speed was 524 mm/s. Toner of which the specific gravity was 1.1 and the particle size was 4.7 μm was used for YMC and toner of which the specific gravity was 1.2 and the particle size was 4.7 μm was used for K. A toner mass per area (TMA) was set to 3.3 g/m² for YMC and set to 3.7 g/m² for K. As a primary transfer device 35, an elastic roller of 428 having a volume resistivity of 7.7 log Ω and an Asuka C hardness of 30° was used. A primary transfer current was set to 54 μA. As the intermediate transfer body 30, an intermediate transfer belt obtained by dispersing carbon in polyimide and having a volume resistivity of 12.5 log Ωcm was used. Regarding the intermediate transfer body cleaning device 36, a cleaning blade having a thickness of 2 mm, formed of urethane rubber, and serving as a plate-shaped cleaning member formed of urethane rubber was brought into contact with a surface of the intermediate transfer belt at a setting angle of 22° and a linear pressure of 2.3 gf/mm.

As the transfer device 50, the belt transfer module 51 obtained by covering the elastic transfer roller 55 of φ28 having a volume resistivity of 6.31 log Ω with a rubber belt of 440 having a thickness of 450 μm and a volume resistivity of 9.2 log Ω as the transfer transport belt 53 and stretching the rubber belt between the elastic transfer roller 55 and a separation roller of φ20 was used and as the facing roller 56, an elastic roller of 28 having an Asuka C hardness of 53° and a surface resistivity of 7.31 log Ω/□ was used via the intermediate transfer body 30.

In addition, SiO₂ having a particle size of 115 nm was used as fine particles and a urethane sponge roller of φ28 having an Asuka C hardness of 15° was used as the application roller 110. Then, the urethane sponge roller holding the fine particles was brought into contact with the intermediate transfer body 30 at a biting amount of 0.5 mm and was rotated relative to the intermediate transfer body 30 at a circumferential speed ratio of 1.5 to apply the fine particles to a surface of the intermediate transfer body 30. The amount of application of fine particles to the intermediate transfer body 30 was adjusted by means of the amount of fine particles held by the urethane sponge roller.

In present Example, a fine particle application control process (refer to FIG. 14) and a bias control process (refer to FIG. 15) of the transfer device 50 adopted in Exemplary Embodiment 2 were performed. Here, in a flowchart shown in FIG. 15, the first threshold value TH1 was set to the fine particle coverage rate Bc=5% and the second threshold value TH2 was set to the fine particle coverage rate Bc=60%. In addition, the special transfer bias Vt1 was set to be optimal for the fine particle coverage rate Bc=30% as the fine particle application amount MS1 and the special transfer bias Vt2 was set to be optimal for the fine particle coverage rate Bc=70% as the fine particle application amount MS2.

Under such a condition, the normal transfer bias Vt0 was applied to execute the normal image forming mode in a case where the fine particles were not applied and the special transfer bias Vt1 or the special transfer bias Vt2 was applied to execute the special image forming mode in a case where the fine particles were applied. As a result, image transferability of a high image quality was observed for both cases.

Note that in the case of application of the normal transfer bias Vt0 in the special image forming mode, a decrease in image quality was observed in comparison with a case where the special transfer bias Vt1 or the special transfer bias Vt2 was applied.

Relationship between Particle Size of Fine Particles, Toner Adhesion Force, and Image Transferability

In a case where fine particles are applied to the intermediate transfer body 30 in present Example, surface unevenness of an applied-fine-particle layer changes depending on the particle size of the fine particles.

Here, in measurement of the surface properties of the intermediate transfer body 30 on which the fine particles have not been applied, an intermediate transfer belt having a surface roughness Rz of 1.5 or less or a microgloss of 93 or more was used.

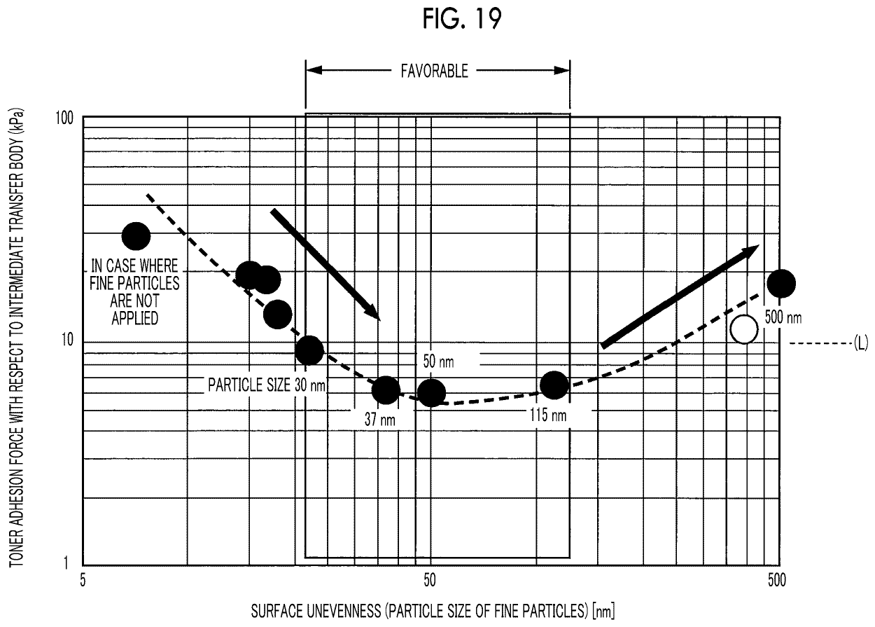

Then, a relationship between the surface unevenness (corresponding to the particle size of the fine particles) [nm] of the applied-fine-particle layer and a toner adhesion force (hereinafter, referred to as a toner adhesion force) [kPa] with respect to the surface of the intermediate transfer body 30 was examined and a result as shown in FIG. 19 was obtained. Here, the toner adhesion force was measured by using a method in which air was blown to a subject obtained by causing fine particles and uncharged toner to adhere onto an intermediate transfer body and a pressure at a time at which the toner started to scatter was measured.

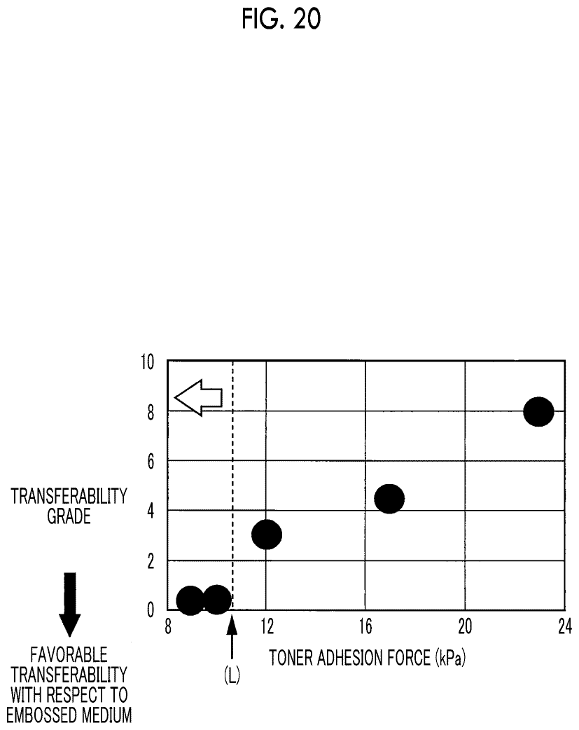

Furthermore, a relationship between a toner adhesion force [kPa] and a transferability grade was examined based on the result shown in FIG. 19 and a result as shown in FIG. 20 was obtained. Here, the transferability grade was obtained by forming an applied-fine-particle layer corresponding to a toner adhesion force on an intermediate transfer belt, causing an image/non-image chart determined in advance to be held on the applied-fine-particle layer, and visually evaluating an image quality exhibited in a case where the image/non-image chart was transferred to embossed paper serving as an embossed medium. The smaller the value of the transferability grade, the better the transferability with respect to the embossed medium.

From FIG. 20, it can be understood that the transferability grade to the embossed medium is favorable in a case where the toner adhesion force is equal to or smaller than a threshold value L (10 kPa is selected in the present example) determined in advance.

Here, in FIG. 19, as a result of examination of a particle size range of the fine particles in which the toner adhesion force is equal to or smaller than the threshold value L (10 kPa), it can be understood that a particle size of 30 to 115 nm is preferable, for example.

Accordingly, it can be understood that the major effect of application of fine particles is to reduce a force of adhesion between toner and a surface of the intermediate transfer body 30 and to make the image transferability favorable.

### Supplementary Note

(((1)))

An image forming system comprising:
an image holding unit that is rotatably provided and that holds an image formed by means of a charged image forming material;
a transfer unit that transfers the image hold by the image holding unit to a medium by using a transfer electric field;
a fine particle applying unit that periodically or irregularly applies lubricant fine particles to the image holding unit; and
a transfer control unit that controls the transfer electric field of the transfer unit depending on a state of application of the fine particles on the image holding unit.
   (((2)))

The image forming system according to (((1))),
wherein the transfer control unit performs control such that the transfer electric field of the transfer unit differs between a condition in which the fine particles have been applied and a condition in which the fine particles have not been applied.
   (((3)))

The image forming system according to (((2))),
wherein the transfer control unit performs control such that the transfer electric field of the transfer unit is made small on a condition in which the fine particles have been applied in comparison with a condition in which the fine particles have not been applied.
   (((4)))

The image forming system according to (((2))) or (((3))),
wherein the transfer control unit performs control such that the transfer electric field of the transfer unit differs depending on an amount of application of the fine particles on a condition in which the fine particles have been applied.
   (((5)))

The image forming system according to (((4))),
wherein, in a case where the amount of application of the fine particles is smaller than a first threshold value determined in advance, the transfer control unit performs control such that the transfer electric field of the transfer unit is made equal to the transfer electric field formed on a condition in which the fine particles have not been applied.
   (((6)))

The image forming system according to (((4))),
wherein, in a case where the amount of application of the fine particles exceeds a second threshold value determined in advance, the transfer control unit performs control such that the transfer electric field of the transfer unit is made large in comparison with a case where the amount of application of the fine particles is equal to or smaller than the second threshold value.
   (((7)))

The image forming system according to any one of (((2))) to (((6))),
wherein the transfer control unit uses a coverage rate of the fine particles as an amount of application of the fine particles on a condition in which the fine particles have been applied and controls the transfer electric field of the transfer unit based on a relationship between the coverage rate of the fine particles and an adhesion force of the image with respect to the image holding unit.
   (((8)))

The image forming system according to any one of (((1))) to (((7))),
wherein the transfer control unit includes a detection unit that detects the state of application of the fine particles and controls the transfer electric field of the transfer unit based on a result of detection performed by the detection unit.
   (((9))

The image forming system according to (((8))),
wherein the detection unit is composed of a reflection type optical sensor that is disposed to face a layer of applied fine particles.
   (((10)))

The image forming system according to any one of (((1))) to (((9))),
wherein the fine particle applying unit applies the fine particles to the image holding unit in a case where an embossed medium having unevenness on a surface of the medium is used.
   (((11))

The image forming system according to any one of (((1))) to (((9))),
wherein the fine particle applying unit applies the fine particles of which a particle size falls within a range of 30 to 150 nm to the image holding unit having a surface roughness Rz of 1.5 or less or a microgloss of 93 or more.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image holding unit that is rotatably provided and that holds an image formed by means of a charged image forming material;
a transfer unit that transfers the image hold by the image holding unit to a medium by using a transfer electric field;
a fine particle applying unit that periodically or irregularly applies lubricant fine particles to the image holding unit; and
a transfer control unit that controls the transfer electric field of the transfer unit depending on a state of application of the fine particles on the image holding unit.

2. The image forming system according to claim 1,
wherein the transfer control unit performs control such that the transfer electric field of the transfer unit differs between a condition in which the fine particles have been applied and a condition in which the fine particles have not been applied.

3. The image forming system according to claim 2,
wherein the transfer control unit performs control such that the transfer electric field of the transfer unit is made small on a condition in which the fine particles have been applied in comparison with a condition in which the fine particles have not been applied.

4. The image forming system according to claim 2,
wherein the transfer control unit performs control such that the transfer electric field of the transfer unit differs depending on an amount of application of the fine particles on a condition in which the fine particles have been applied.

5. The image forming system according to claim 4,
wherein, in a case where the amount of application of the fine particles is smaller than a first threshold value determined in advance, the transfer control unit performs control such that the transfer electric field of the transfer unit is made equal to the transfer electric field formed on a condition in which the fine particles have not been applied.

6. The image forming system according to claim 4,
wherein, in a case where the amount of application of the fine particles exceeds a second threshold value determined in advance, the transfer control unit performs control such that the transfer electric field of the transfer unit is made large in comparison with a case where the amount of application of the fine particles is equal to or smaller than the second threshold value.

7. The image forming system according to claim 2,
wherein the transfer control unit uses a coverage rate of the fine particles as an amount of application of the fine particles on a condition in which the fine particles have been applied and controls the transfer electric field of the transfer unit based on a relationship between the coverage rate of the fine particles and an adhesion force of the image with respect to the image holding unit.

8. The image forming system according to claim 1,
wherein the transfer control unit includes a detection unit that detects the state of application of the fine particles and controls the transfer electric field of the transfer unit based on a result of detection performed by the detection unit.

9. The image forming system according to claim 8,
wherein the detection unit is composed of a reflection type optical sensor that is disposed to face a layer of applied fine particles.

10. The image forming system according to claim 1,
wherein the fine particle applying unit applies the fine particles to the image holding unit in a case where an embossed medium having unevenness on a surface of the medium is used.

11. The image forming system according to claim 1,
wherein the fine particle applying unit applies the fine particles of which a particle size falls within a range of 30 to 150 nm to the image holding unit having a surface roughness Rz of 1.5 or less or a microgloss of 93 or more.

12. An image forming system comprising:
image holding means for holding an image formed by means of a charged image forming material, the image holding means being rotatably provided;
transferring means for transferring the image hold by the image holding means to a medium by using a transfer electric field;
fine particle applying means for periodically or irregularly applying lubricant fine particles to the image holding means; and
transfer controlling means for controlling the transfer electric field of the transferring means depending on a state of application of the fine particles on the image holding means.
